(19) United States
(12) Patent Application Publication
(10) Pub. No.: US 2013/0040026 A1
(43) Pub. Date: Feb. 14, 2013

(54) EXTENDED SHELF-LIFE LIQUIDS AND METHOD THEREOF

(71) Applicants: Shmuel Bukshpan, Ramat Hasharon (IL); Gleb Zilberstein, Rehovot (IL)

(72) Inventors: Shmuel Bukshpan, Ramat Hasharon (IL); Gleb Zilberstein, Rehovot (IL)

(21) Appl. No.: 13/512,969

(22) PCT Filed: Dec. 2, 2010
(86) PCT No.: PCT/IL10/01016

§ 371 Date: Nov. 2, 2012

Related U.S. Application Data
(60) Provisional application No. 61/265,767, filed on Dec. 2, 2009.

(51) Int. Cl. A23L 2/44; A01N 41/04; A01P 1/00; A01N 61/00

(52) U.S. Cl. 426/326; 426/532; 424/78.11; 424/78.27

(57) ABSTRACT

A method of producing a liquid substantially free of beverage spoiling microorganisms, characterized in that said method comprises steps of: (a) obtaining a liquid; (b) obtaining a bioactive material that does not affect a predetermined set of organoleptic parameters of said liquid upon contact with said concentrate for a predetermined length of time; and, (c) treating said liquid with said bioactive material until the concentration of beverage-spoiling microorganism falls below a predetermined threshold.

### FIELD OF THE INVENTION

The present invention is directed towards the beverage industry. More particularly the present invention pertains to means and methods of producing beverages substantially free of pathogens and spoilage microbes in which the beverage retains its taste and other organoleptic properties after treatment.

### BACKGROUND OF THE INVENTION

Many consumer and medical products are provided in liquid form or contain liquid components. Many of these products are susceptible to spoilage due to the action of bacteria, molds, yeasts, fungi, etc., which limits the shelf life of the product. Thus, a considerable effort has been made to find ways to limit such spoilage mechanisms, thereby increasing the shelf life and viability of the product.

For example, the beverage industry accounts for some $90 billion in annual sales in the U.S. alone. Industrially produced beverages are made in highly sophisticated factories, and are canned or bottled for the end user, or produced as concentrates or syrups which are then later diluted at other manufacturing facilities and then bottled or canned, or produced as an initial concentrate or syrup which is then distributed to point of sale dispensers, where water is added, and/or carbonation is carried out and dispensed to the customer.

One problem faced by manufacturers and consumers of beverages is the limited shelf life of most beverages. A major cause of this limited shelf life is the activity of spoilage organisms within the beverage after it has been placed in its end-use container. Microbial infestation can also lead to serious illness in the consumer who is unfortunate enough to ingest a beverage in which a pathogenic, organism has bred. Many methods for removing pathogenic and spoilage organisms and for thus extending the shelf life of beverages have been developed, such as addition of preservatives, pasteurization, and irradiation. While these methods are successful in delaying the time before the beverage spoils, they suffer from numerous serious drawbacks. Most of these methods adversely affect the taste and nutritive value of the beverage so treated, and in addition, these methods tend to be unpopular either due to their leading to the presence of additives in the beverage or to perceived lack of safety in the method. In recent years, attempts have been made to develop methods in which the packaging in which the liquid is stored contains a preservative material.

The problem of spoilage frequently arises in beverages. Because of their utilisation of sugars, yeasts are of most immediate concern.

Yeasts are classified with the fungi and are unicellular for most of their lifecycle. Together with moulds and bacteria they can bring about deterioration in flavour, producing taints, off-notes, differences in mouthfeel and so on. Most yeasts can grow with or without oxygen, whereas most bacteria cannot survive in it. The majority of yeasts thrive in temperatures between 25 and 27° C.; some can survive at temperatures over 70° C. and others can exist, apparently quite comfortably, at 0-10° C. Bacteria exhibit some similar diversity in their characteristics, with an optimum growth temperature at around 37° C. Soft drinks provide an ideal growth substrate for many micro-organisms, providing them with adequate supplies of the nutrients they require. Apart from water, the environmental necessity, typical requirements are sources of carbon (carbohydrates), nitrogen (amino acids), phosphorus (phosphates), potassium, calcium (mineral salts) and traces of other minerals, for example, sulphur, iron, cobalt and even vitamins. Because of its obvious link with protein formation during cell growth, the presence of combined nitrogen is of particular importance. Also, when it is introduced to beverages via fruit pulp or caramel (colouring), there will be a greater susceptibility to spoilage by certain microorganisms. Perhaps the most difficult aspect of dealing with microbial contamination in soft drinks relates to the delay factor: an apparently good-quality product may leave the bottling line for storage and distribution only to be returned at a later date, maybe after several weeks, when severe deterioration has taken place. Fortunately, such occurrences are seldom encountered in today's soft drinks industry, but to any manufacturer it is a nightmare scenario that must be avoided at all costs. A bottled drink constitutes a unique system, which can inhibit or enhance the growth of micro-organisms. Micro-flora, if present, will enter a dormant stage during which their chances of survival are related to their immediate surroundings. Following this lag stage, during which specific micro-flora may adapt to their new environment and start to grow, there is a burst of species dependent activity, during which the population doubles repeatedly at a steady rate. Since a bottled drink is a closed system, waste products and diminishing nutrients will serve to slow down the growth and eventually bring it to a standstill, when the death rate increases and all activity stops. At this point the product, although perhaps not a health hazard, has been spoiled and can no longer serve its intended function.

The microbiocidal effect increases as the pH falls below 4.0, and because of this, SO₂ is ideally suited for most soft drink formulations. However, its preserving action is impaired by a tendency to react with many of the fruit components of soft drinks to form organic sulphites, in which state the SO₂ is said to be ‘bound’. Although the preservative properties are due mainly to free SO₂, it is necessary to analyse for total SO₂ (i.e. free plus bound) as legislation for safe levels refers only to maximum total concentrations.

Although SO₂ is used to good effect in the preservation of concentrated citrus juices, with typical concentrations of 1,000-2,000 ppm m/v, it is now limited under EU legislation to no more than 20 ppm in non-alcoholic flavoured drinks containing fruit juice, and only as carry-over from concentrates (ref. 95/2/EC; see Table 5.7). There are a number of specific drink products which are permitted to contain higher levels of SO₂ under the same legislation—for example, concentrates/dilutables based on fruit juice and containing not less than 2.5% barley (barley water). However, since this limit has been much reduced from a previous level of 70 ppm, the onus has been squarely placed on manufacturers to attain improved manufacturing practices in terms of plant hygiene. JECFA has recommended an ADI of not more than 0.7 mg/kg body weight for SO₂.

Disadvantages associated with sulphur dioxide are that some tasters can detect it as an unpleasant backnote or taint and it has a tendency to provoke allergic reactions in some individuals. Asthma sufferers tend to be affected by gaseous sulphur dioxide, small traces of which can promote an asthmatic attack. There is a risk with foods containing sulphites of gas liberation upon swallowing.

Benzoic acid occurs naturally in some fruits and vegetables, notably in cranberries, where it occurs in amounts of the order of 0.08% m/m (Fellows & Esselen, 1955). It is also found in some resins, chiefly in gum benzoin (from Styrax benzoia), and in coal tar. Commercially available benzoic acid is produced by chemical synthesis.

Pure benzoic acid is a white powdery crystalline solid (m.p. 122° C.) only sparingly soluble in water at normal temperatures. Because of this, it is added to the drink in the soluble form of its sodium or potassium salts. It is normal practice to disperse the benzoate completely during batch makeup before addition of the acid component, with its resulting pH reduction, to avoid localised precipitation of the ‘free’ benzoic acid due to its solubility having been exceeded (the solubility of benzoic acid is 0.35% m/v at 20° C.). It is the free or undissociated form of benzoic acid that exhibits preservative action and hence its use is only effective when low pH values are encountered, ideally below pH 3, at which point the degree of dissociation reduces to below 10%. Benzoic acid is generally considered to exhibit an inhibitory effect on microbial growth, although it is of little use for bacterial control, where the greatest problem will occur at pH values above 4, outside the effective limit mentioned above. Improved results are obtained when it is used in conjunction with other preservatives, for example, SO₂ or sorbic acid, due to synergistic effects. It is interesting to note that the current European Directive, which sets individual limits of 300 mg/l for sorbic acid and 150 mg/l for benzoic acid in non-alcoholic flavoured drinks, nevertheless permits a joint preservative use of up to 250 mg/l sorbic acid with 150 mg/l benzoic acid.

Allergic responses to benzoic acid have been reported, particularly among children known to be made hyperactive by other agents, for example, tartrazine. The maximum ADI for benzoic acid, recommended by JECFA, is 5 mg/kg body weight.

Perhaps the most common problem encountered during storage of a beverage relates to the oxidation effects involving certain ingredients. Both flavour and colour components can be subject to deterioration in the presence of dissolved oxygen, to the detriment of the product. Antioxidants are therefore included in those formulations containing ingredients most vulnerable to oxidation. Oxidation can frequently be attributed to the oxygen permeability of the plastic materials used in container manufacture, but it is essential that the oxidation process should not start at the production stage of the drink or any of its ingredients.

Citrus-flavoured drinks, notably lemon drinks, are frequently susceptible to oxidation and so antioxidants may feature in their formulation. Oil-based, water-dispersible flavours (emulsions) are protected by the addition of oil-soluble antioxidants such as butylated hydroxy anisole (BHA) and butylated hydroxy toluene (BHT) to the oil phase before the emulsification process; 1,000 mg/l is the typical usage level in essential oils. Since the flavour emulsion will be used at the rate of about 0.1%, the level of antioxidant in the finished beverage will be of the order of 1 mg/l, which will safely comply with an ADI of 5 mg/kg body weight for either additive.

Increasing use is being made of natural and nature-identical antioxidants because in many countries use of BHA and BHT continues to be restricted on health grounds. Ascorbyl palmitate (6-O-palmitoyl-L-ascorbic acid) and its sodium and calcium salts, natural extracts rich in tocopherols (vacuum-distilled from soya-bean oil, wheat germ, rice germ and cottonseed oil, for example) and synthetic α, β, and γ-tocopherols are used to good effect in preventing oxidative deterioration in oil-based systems. In combination, ascorbyl palmitate and -tocopherol (vitamin E) synergise to exhibit enhanced antioxidant properties.

This mixed salt of ethylene diamine tetraacetic acid (EDTA) is prepared by reacting the acid with a mixture of calcium and sodium hydroxides. It acts as a sequestrant, its binding action removing traces of metal ions present in raw materials or process water. These metals, for example, iron, can destabilise a beverage by a tendency to catalyse degradation of flavouring components, causing oxidation and off-notes. Their removal serves to maintain stability of the products during storage and to increase shelf life.

Under European Directive 95/2/EC, calcium disodium EDTA is permitted only in a limited number of foods, including some canned and bottled products, with maximum levels specified in each case. In the United States (Code of Federal Regulations) it is permitted to a level of 33 ppm in canned carbonated soft drinks, to promote flavour retention.

A few patents have addressed the issue of modulation of the plastic material, such as laminating, coating (U.S. Pat. No. 3,561,629 laminated or coated blow molded containers), or multi-layering it (U.S. Pat. No. 4,040,233 Multi-layer blow molded container and process for preparation thereof, U.S. Pat. No. 4,646,925 Multi-layer preform for draw-blow forming a bottle), for a variety of purposes: mixing recycled PET with new material, changing wall characteristics, reducing carbonation level of carbonation beverages to name a few. U.S. Pat. No. 7,258,804 pertains to modulating the plastic material of a beverage bottle for antibacterial purposes. All of those patents relate to the blown portion of the bottle or the blown and opening portions together.

US patent application 20050271780 teaches a bactericidal polymer matrix being bound to an ion exchange material such as a quaternary ammonium salt for use in food preservation. This polymer matrix kills bacteria by virtue of incorporating therein of a bactericidal agent (e.g. the quaternary ammonium salt). The positive charge of the agent merely aids in electrostatic attraction between itself and the negatively charged cell walls. In addition, the above described application does not teach use of solid buffers having a buffering capacity throughout their entire body.

US patent application 20050249695 teaches immobilization of antimicrobial molecules such as quarternary ammonium or phosphonium salts (cationic, positively charged entities) covalently bound onto a solid surface to render the surface bactericidal. The polymers described herein are attached to a solid surface by virtue of amino groups attached thereto and as such the polymer is only capable of forming a monolayer on the solid surface. The antimicrobial action of these kinds of polymers is a result of disruption of the microbial cell membrane when it interacts with the amino or phosphonium groups, and thus, only those microbes that come into physical contact with the polymer surface will be affected.

The activity of the polymers as described in US patent applications 20050271780, 20050249695 and 20050003163 relies on the direct contact of the bactericidal materials with the cellular membrane. The level of toxicity is strongly dependent on the surface concentration of the bactericidal entities. This requirement presents a strong limitation since the exposed cationic materials can be saturated very fast in ion exchange reactions.

US patent application 20050226967 and U.S. Pat. No. 7,258,916 discloses packaging material that inhibits growth of harmful microorganisms by removing or sequestering metal ions such as Zn, Cu, Mn and Fe, trace elements essential for biological growth.

US patent application 20060003019 discloses a material surface with separated areas of anode and cathode material, with antibacterial activity based on an iontophoretic effect and release of dissolved ions.

US patent 20040156918 discloses Zeolite-containing dispersions used to place an anti-microbial coating onto packaging materials.

Patent JP2004121187 discloses mixing a plastic material with powder of tourmaline. The freshness of the food is maintained by the generation of minus ion from the tourmaline.

U.S. Pat. No. 6,172,040 discloses a method for treating products with immobilized lactoferrin to reduce microbial contamination. A method of inhibiting the growth and/or adhesion of a microbial species on material for food packaging is also disclosed, relating mainly to meat packaging, not beverages.

It can be seen that these methods are either inappropriate for or of limited use as means of providing long-term stability and protection against spoilage to canned or bottled beverages; packaging made from these materials will be of limited effectiveness, or too expensive to be cost-effective, or material (possibly incompatible with use in the food industry) will leach out of the packaging into the beverage. Thus, a beverage free of spoilage or pathogenic organisms that remains uninfected over a long period of time, and a method for producing such a beverage by a method that (1) does not introduce extraneous material into the beverage and (2) does not reduce the palatability of the beverage by changing its taste, odor, texture, appearance, etc. remain long-felt needs.

### SUMMARY OF THE INVENTION

It is thus an object of the present invention to provide extended shelf-life liquids that avoid these problems and a method for producing them.

It is therefore an object of the present invention to disclose a method of producing a liquid substantially free of beverage spoiling microorganisms, characterized in that said method comprises steps of (a) obtaining a liquid; (b) obtaining a bioactive material that does not affect a predetermined set of organoleptic parameters of said liquid upon contact with said concentrate for a predetermined length of time; and (c) treating said liquid with said bioactive material until the concentration of beverage-spoiling microorganism falls below a predetermined threshold.

It is therefore an object of the present invention to disclose a method of producing a liquid substantially free of beverage-spoiling microorganisms, characterized in that said method comprises steps of (a) obtaining a liquid concentrate; (b) obtaining a diluent; (c) obtaining a bioactive material that does not affect a predetermined set of organoleptic parameters of said concentrate upon contact with said concentrate for a predetermined length of time; (d) treating said liquid concentrate with said bioactive material until the concentration of beverage-spoiling microorganisms falls below a predetermined threshold; and (e) combining said diluent with the treated liquid concentrate.

It is therefore an object of the present invention to disclose a method of producing an extended shelf life liquid, characterized in that said method comprises steps of (a) obtaining a liquid; (b) obtaining a bioactive material that does not affect a predetermined set of organoleptic parameters of said liquid upon contact with said concentrate for a predetermined length of time; and (c) treating said liquid with said bioactive material.

It is therefore an object of the present invention to disclose a method of producing an extended shelf life liquid, characterized in that said method comprises steps of (a) obtaining a liquid concentrate; (b) obtaining a diluent; (c) obtaining a bioactive material that does not affect a predetermined set of organoleptic parameters of said concentrate upon contact with said concentrate for a predetermined length of time; (d) treating said liquid concentrate with said bioactive material; and (e) combining said diluent with the treated concentrate.

It is therefore an object of the present invention to disclose a method of producing a liquid concentrate substantially free of beverage spoiling microorganisms, characterized in that said method comprises steps of (a) obtaining a liquid concentrate; (b) obtaining a bioactive material that does not affect a predetermined set of organoleptic parameters of said concentrate upon contact with said concentrate for a predetermined length of time; and (c) treating said liquid concentrate with said bioactive material until the concentration of beverage-spoiling microorganisms falls below a predetermined threshold.

It is therefore an object of the present invention to disclose a method of producing an extended shelf life liquid concentrate, characterized in that said method comprises steps of (a) obtaining a liquid concentrate; (b) obtaining a bioactive material that does not affect a predetermined set of organoleptic parameters of said concentrate upon contact with said concentrate for a predetermined length of time; and (c) treating said liquid concentrate with said bioactive material.

It is a further object of this invention to disclose such a method, wherein said step of obtaining a diluent further comprises a step of obtaining a diluent chosen from the group consisting of (a) water and (b) carbonated water.

It is a further object of this invention to disclose such a method for producing such a liquid, further comprising a step of obtaining combining means for combining said diluent and said liquid concentrate, wherein said step of combining said liquid concentrate and said diluent further comprises a step of using said combining means to combine said diluent and said liquid concentrate, and further wherein said step of treating said liquid concentrated with said bioactive material further comprises a step of treating at least one of (a) said liquid concentrate and (b) at least part of a mixture obtained by combining said liquid concentrate and said diluent with said bioactive material.

It is a further object of this invention to disclose such a method as defined in any of the above, wherein said step of obtaining a bioactive material that does not affect a predetermined set of organoleptic parameters of said concentrate upon contact with said concentrate for a predetermined length of time further comprises a step of obtaining a bioactive material comprising a solid substantially insoluble in water which, when in contact with a water-containing environment, carries carrying strongly acid and/or strongly basic functional groups; has a pH of less than about 4.5 or greater than about 8.0; and is in a form chosen from the group consisting of (i) H⁺ and (ii) OH⁻.

It is a further object of this invention to disclose such a method, wherein said step of treating with said bioactive material further comprises a step of continuing said step of treating with said bioactive material as long as the pH remains within 0.6 pH units of its value at the time that said step begins.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material that is characterized as a solid buffer.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a solid buffer characterized, when said groups are accessible to water, as having a buffering capacity of about 20 to about 100 mM H⁺/L/pH unit.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material characterized, when said functional groups are accessible to water, by at least one characteristic chosen from the group consisting of (a) sufficiently water-insoluble such that at least 99.9% remains undissolved at equilibrium; (b) sufficiently resistant to leaching such that the total concentration of material leached from said composition of matter into said water-containing environment does not exceed 1 ppm; (c) sufficiently inert such that at least one parameter of said water-containing environment chosen from the group consisting of (i) concentration of at least one predetermined water-soluble substance; (ii) particle size distribution; (iii) rheology; (iv) toxicity; (v) color; (vi) taste; (vii) smell; and (viii) texture remains unaffected according to preset conditions, said conditions adapted for and appropriate to said particular environment.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material that further comprises at least one polymer chosen from the group consisting of (a) polyvinyl alcohol; (b) polystyrene sulfonate; and (c) polypropylene polystyrene-divinylbenzene.

It is a further object of this invention to disclose such a method, wherein said at least one polymer contains at least one functional group chosen from the group consisting of SO₃H and H₂N(CH₃).

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material further comprising hydrophilic additives chosen from the group consisting of (a) sulfonated tetrafluoroethylene copolymers; (b) sulfonated materials chosen from the group consisting of silica, polythion-ether sulfone (SPTES), styrene-ethylene-butylene-styrene (S-SEBS), polyether-ether-ketone (PEEK), poly(arylene-ether-sulfone) (PSU), polyvinylidene fluoride (PVDF)-grafted styrene, polybenzimidazole (PBI), and polyphosphazene; and (c) proton-exchange membranes made by casting a polystyrene sulfonate (PSSnate) solution with suspended micron-sized particles of cross-linked PSSnate ion exchange resin.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material further comprising two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material further comprising a surface with a given functionality and at least one external proton-permeable layer, each of which of said at least one external proton-permeable layers is disposed on at least a portion of said surface.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material further comprising at least one charged polymer and at least one barrier adapted to prevent heavy ion diffusion.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material in a form chosen from the group consisting of (a) powder; (b) gel; (c) suspension; (d) spray; (e) resin; (f) coating; (g) film; (h) sheet; (i) bead; (j) particle; (k) microparticle; (l) nanoparticle; (m) fiber; (n) thread.

It is a further object of this invention to disclose such a method, wherein said step of obtaining a bioactive material that does not affect a predetermined set of organoleptic parameters of said concentrate upon contact with said concentrate for a predetermined length of time further comprises a step of obtaining a bioactive material further characterized by at least one of the following: (a) capacity for absorbing or releasing protons capable of regeneration; (b) buffering capacity capable of regeneration; and (c) proton conductivity capable of regeneration.

It is a further object of this invention to disclose such a method as defined in any of the above, wherein said predetermined set of organoleptic parameters comprises at least one organoleptic parameter chosen from the group consisting of: concentration of at least one predetermined water-soluble substance; size distribution of insoluble substances; initial taste; flavor; aftertaste; odor; color; appearance; texture; feel in the mouth; astringency; sweetness; bitterness; saltiness; off flavors; viscosity.

It is a further object of this invention to disclose such a method as defined in any of the above, wherein said step of obtaining a bioactive material that does not affect a predetermined set of organoleptic parameters upon contact for a predetermined length of time further includes a step of obtaining a bioactive material that does not affect a predetermined set of organoleptic parameters as measured by the methods defined by ASTM standard E2454-05 upon contact for a predetermined length of time.

It is a further object of this invention to disclose such a method as defined in any of the above, wherein said step of obtaining a bioactive material that does not affect a predetermined set of organoleptic parameters upon contact for a predetermined length of time further includes a step of obtaining a bioactive material that does not leach any substance capable of affecting a parameter selected from the group consisting of pH; viscosity; density; ionic concentration; conductivity; carbon dioxide concentration; oxygenation; concentration of at least one predetermined water-soluble substance; size distribution of insoluble substances; initial taste; flavor; aftertaste; odor; color; appearance; texture; feel in the mouth; astringency; sweetness; bitterness; saltiness; off flavors; viscosity; and any combination of the above.

It is a further object of this invention to disclose such a method as defined in any of the above, wherein said step of treating with said bioactive material until the concentration of beverage-spoiling microorganism falls below a predetermined threshold further comprises a step of treating with said bioactive material until the concentration of beverage-spoiling microorganism falls below the maximum concentration set by law.

It is a further object of this invention to disclose such a method as defined in any of the above, wherein said step of treating with said bioactive material until the concentration of beverage-spoiling microorganism falls below a predetermined threshold further comprises a step of treating with said bioactive material until the concentration of beverage-spoiling microorganism falls below 10⁻² CFU ml⁻¹.

It is a further object of this invention to disclose such a method as defined in any of the above, wherein said step of obtaining a liquid further comprises a step of obtaining a liquid characterized by at least one characteristic chosen from the group consisting of (a) unpasteurized; (b) pasteurized for less time than is customary for a liquid not treated by said method; (c) unheated; (d) preservative-free; (e) unfiltered; (f) not centrifuged; (g) not frozen; (h) not freeze-dried; and (i) unprocessed.

It is a further object of this invention to disclose such a method, wherein said step of obtaining a liquid concentrate further comprises a step of obtaining a liquid concentrate characterized by at least one characteristic chosen from the group consisting of (a) unpasteurized; (b) pasteurized for less time than is customary for a liquid not treated by said method; (c) unheated; (d) preservative-free; (e) unfiltered; (f) not centrifuged; (g) not frozen; (h) not freeze-dried; and (i) unprocessed.

It is a further object of this invention to disclose such a method, wherein said step of obtaining a liquid further comprises a step of obtaining a beverage chosen from the group consisting of water, mineral water, soda water, carbonated beverages, flavoured carbonated beverages, non-carbonated beverages, still beverages, ready-to-drink beverages, beverages containing alcohol, diet beverages, beverages with added caramel, beverages with artificial citrus flavourings, beverages with artificial cola flavourings, artificially flavored beverages, artificially sweetened beverages, naturally sweetened beverages, sugar sweetened beverages, energy beverages, draft beverages, fruit juice based beverages, natural beverages, natural fruit beverages, freshly squeezed fruit beverages, vegetable juice based beverages, canned beverages, bottled beverages, refrigerated beverages, tea based beverages, iced tea, brewed tea, carbonated water with additional flavoring, carbonated water with fruit flavoring, carbonated beverages with added juice, milk, buttermilk, milk based beverages, milk powder based beverages, carbonated milk beverages, sterilised beverages, and pasteurised beverages.

It is a further object of this invention to disclose such a method, wherein said step of obtaining a liquid concentrate further comprises a step of obtaining a beverage concentrate useful for production of a beverage chosen from the group consisting of water, mineral water, soda water, carbonated beverages, flavoured carbonated beverages, non-carbonated beverages, still beverages, ready-to-drink beverages, beverages containing alcohol, diet beverages, beverages with added caramel, beverages with artificial citrus flavourings, beverages with artificial cola flavourings, artificially flavored beverages, artificially sweetened beverages, naturally sweetened beverages, sugar sweetened beverages, energy beverages, draft beverages, fruit juice based beverages, natural beverages, natural fruit beverages, freshly squeezed fruit beverages, vegetable juice based beverages, canned beverages, bottled beverages, refrigerated beverages, tea based beverages, iced tea, brewed tea, carbonated water with additional flavoring, carbonated water with fruit flavoring, carbonated beverages with added juice, milk, buttermilk, milk based beverages, milk powder based beverages, carbonated milk beverages, sterilised beverages, and pasteurised beverages

It is a further object of this invention to disclose such a method as defined in any of the above, further comprising a step of bottling the treated liquid in a manner chosen from the group consisting of (a) anaerobically, (b) aerobically, (c) by a means other than hot filling, and (d) by a means other than aseptic filling.

It is a further object of this invention to disclose such a method, wherein said beverage-spoiling microorganism is a pathogen.

It is a further object of this invention to disclose such a method, wherein said beverage-spoiling microorganism is chosen from the group consisting of bacteria, viruses, yeasts, microbes, algae, molds, and fungi, and any combination thereof.

It is a further object of this invention to disclose such a method, wherein said beverage-spoiling microorganism is a microorganism capable performing at least one action chosen from the group consisting of (a) increasing the rate of spoilage of a product, (b) decreasing the palatability of a product, (c) decreasing the quality of at least one organoleptic parameter associated with a product, (d) causing an illness in a mammal that ingests a product, and (e) producing a substance that can cause detrimental effects to the health of a mammal that ingests a product.

It is a further object of this invention to disclose such a method, wherein said product is chosen from the group consisting of (a) foodstuffs, (b) medications, and (c) cosmetics.

It is a further object of this invention to disclose such a method as defined in any of the above, further comprising a step of bottling the treated liquid in a bottle with a headspace.

It is a further object of this invention to disclose such a method as defined in any of the above, further comprising a step of bottling the treated liquid in a bottle without a headspace.

It is a further object of this invention to disclose a liquid and a liquid concentrate produced according to the methods herein disclosed.

It is a further object of this invention to disclose such a liquid, wherein the liquid is a beverage, foodstuff, medication, or cosmetic, or is at least partially contained within a foodstuff, medication, or cosmetic.

It is a further object of this invention to disclose such a liquid or liquid concentrate, wherein said liquid or liquid concentrate is stored in a container comprising a bioactive material.

It is a further object of this invention to disclose such a liquid or liquid concentrate, wherein said bioactive material comprises a solid substantially insoluble in water which, when in contact with a water-containing environment, carries carrying strongly acid and/or strongly basic functional groups; has a pH of less than about 4.5 or greater than about 8.0; and is in a form chosen from the group consisting of (i) H⁺ and (ii) OH⁻.

It is a further object of this invention to disclose such a liquid or liquid concentrate, wherein said bioactive material comprises a solid buffer.

It is a further object of this invention to disclose such a liquid or liquid concentrate, wherein said bioactive material comprises a solid buffer characterized, when said groups are accessible to water, as having a buffering capacity of about 20 to about 100 mM H⁺/L/pH unit.

It is a further object of this invention to disclose such a liquid or liquid concentrate, wherein said bioactive material is characterized, when said functional groups are accessible to water, by at least one characteristic chosen from the group consisting of (a) sufficiently water-insoluble such that at least 99.9% remains undissolved at equilibrium; (b) sufficiently resistant to leaching such that the total concentration of material leached from said composition of matter into said water-containing environment does not exceed 1 ppm; (c) sufficiently inert such that at least one parameter of said water-containing environment chosen from the group consisting of (i) concentration of at least one predetermined water-soluble substance; (ii) particle size distribution; (iii) rheology; (iv) toxicity; (v) color; (vi) taste; (vii) smell; and (viii) texture remains unaffected according to preset conditions, said conditions adapted for and appropriate to said particular environment.

It is a further object of this invention to disclose such a liquid or liquid concentrate, wherein said bioactive material comprises at least one polymer chosen from the group consisting of (a) polyvinyl alcohol; (b) polystyrene sulfonate; and (c) polypropylene polystyrene-divinylbenzene.

It is a further object of this invention to disclose such a liquid or liquid concentrate, wherein said polymer contains at least one functional group chosen from the group consisting of SO₃H and H₂N(CH₃).

It is a further object of this invention to disclose such a liquid or liquid concentrate, wherein said bioactive material comprises hydrophilic additives chosen from the group consisting of (a) sulfonated tetrafluoroethylene copolymers; (b) sulfonated materials chosen from the group consisting of silica, polythion-ether sulfone (SPTES), styrene-ethylene-butylene-styrene (S-SEBS), polyether-ether-ketone (PEEK), poly(arylene-ether-sulfone) (PSU), polyvinylidene fluoride (PVDF)-grafted styrene, polybenzimidazole (PBI), and polyphosphazene; and (c) proton-exchange membranes made by casting a polystyrene sulfonate (PSSnate) solution with suspended micron-sized particles of cross-linked PSSnate ion exchange resin.

It is a further object of this invention to disclose such a liquid or liquid concentrate, wherein said bioactive material comprises two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

It is a further object of this invention to disclose such a liquid or liquid concentrate, wherein said bioactive material comprises a surface with a given functionality and at least one external proton-permeable layer, each of which of said at least one external proton-permeable layers is disposed on at least a portion of said surface.

It is a further object of this invention to disclose such a liquid or liquid concentrate, wherein said bioactive material comprises at least one charged polymer and at least one barrier adapted to prevent heavy ion diffusion.

It is a further object of this invention to disclose such a liquid or liquid concentrate, wherein said bioactive material is provided in a form chosen from the group consisting of (a) powder; (b) gel; (c) suspension; (d) spray; (e) resin; (f) coating; (g) film; (h) sheet; (i) bead; (j) particle; (k) microparticle; (l) nanoparticle; (m) fiber; (n) thread.

It is a further object of this invention to disclose such a liquid or liquid concentrate, wherein said bioactive material is characterized by at least one of the following: (a) capacity for absorbing or releasing protons capable of regeneration; (b) buffering capacity capable of regeneration; and (c) proton conductivity capable of regeneration.

It is a further object of this invention to disclose such a liquid or liquid concentrate, wherein said container is adapted to be stored in a position chosen from the group consisting of venially, horizontally, or inverted.

It is a further object of this invention to disclose such a liquid or liquid concentrate, wherein said container is adapted to be stored in a plurality of positions and further adapted to have its storage position changed between at least two of said plurality of storage positions at least once during the time that said container is being stored.

It is a further object of this invention to disclose such a liquid or liquid concentrate, wherein said change in said storage position is performed after a preset interval following the commencement of said storage.

It is a further object of this invention to disclose such a liquid or liquid concentrate, wherein said preset interval is less than or equal to about 3 days.

It is a further object of this invention to disclose such a liquid or liquid concentrate, wherein said preset interval is less than or equal to about 7 days.

It is a further object of this invention to disclose such a liquid or liquid concentrate, wherein said preset interval is less than or equal to about 14 days.

It is a further object of this invention to disclose such a liquid or liquid concentrate, wherein said preset interval is less than or equal to about 30 days.

It is a further object of this invention to disclose such a liquid or liquid concentrate, wherein said preset interval is less than or equal to about 60 days.

It is a further object of this invention to disclose such a liquid or liquid concentrate, wherein said preset interval is less than or equal to about 120 days.

It is a further object of this invention to disclose such a liquid or liquid concentrate, wherein said container further comprises an insert, said insert comprising said bioactive material.

It is a further object of this invention to disclose such a liquid or liquid concentrate, wherein said container further comprises a closure comprising said bioactive material.

It is a further object of this invention to disclose such a liquid or liquid concentrate, wherein said closure is chosen from the group consisting of plug, stopper, cap, screw-on cap, or seal.

It is a further object of this invention to disclose such a liquid or liquid concentrate, wherein said bioactive material is incorporated into the material from which said closure is constructed.

It is a further object of this invention to disclose such a liquid or liquid concentrate, wherein said bioactive material is disposed as a layer on at least part of the inner surface of said closure.

It is a further object of this invention to disclose such a liquid or liquid concentrate, wherein said closure comprises a lining, said lining disposed about at least part of the inner surface of said closure and said lining comprising said bioactive material.

It is a further object of this invention to disclose such a liquid or liquid concentrate, wherein said closure comprises an insert, said insert disposed about at least a part of the inner surface of said closure, said insert comprising said bioactive material.

It is a further object of this invention to disclose such a liquid or liquid concentrate,

wherein the lumen of said container is characterized by flowability in a measure suitable for spraying, irrigating, gluing, embedding, melting, evaporating, immersing, doping, immobilizing, entrapping, coating, directing, or otherwise facilitatedly flowing either adjacent to a container's mouth or within said preform's lumen.

It is a further object of this invention to disclose such a liquid or liquid concentrate, wherein said lumen of said container is characterized by a flowability of more than an effective measure according to ASTM standard C1339.

It is a further object of this invention to disclose such a liquid or liquid concentrate, wherein said lumen of said container is characterized by a flowability of more than an effective measure according to ASTM standard D6103.

It is a further object of this invention to disclose such a liquid or liquid concentrate, wherein said container additionally comprises an effective measure of at least one additive.

It is a further object of this invention to disclose such a liquid or liquid concentrate, wherein said additive is selected from a group consisting of an accelerator, an adhesion promoter, an antifoamer, anti-insect additive, an antioxidant, an antiskinning agent, a buffer, a catalyst, a coalescing agent, a corrosion inhibitor, a defoamer, a dehydrator, a dispersant, a drier, electrical additive, an emulsifier, a filler, a flame/fire retardant, a flatting agent, a flow control agent, a gloss aid, a leveling agent, a marproofing agent, a preservative, a silicone additive, a slip agent, a surfactant, a light stabilizer, a rheological control agent, a wetting additive, a cryopreservative, a xenoprotectant, biocides, markers, biomarkers, dyes, pigments, radio-labeled materials, glues, adhesives, lubricants, medicaments, sustained release drugs, nutrients, peptides, amino acids, polysaccharides, enzymes, hormones, chelators, multivalent ions, emulsifying or de-emulsifying agents, binders, fillers, thickeners, factors, co-factors, enzymatic-inhibitors, organoleptic agents, carrying means, such as liposomes, MLVs or other vesicles, magnetic or paramagnetic materials, ferromagnetic and non-ferromagnetic materials, biocompatibility-enhancing materials and/or biodegradating materials, such as polylactic acids and polyglutamic acids, anticorrosive pigments, anti-fouling pigments, UV absorbers, UV enhancers, blood coagulators, inhibitors of blood coagulation, pesticides, fungicides, herbicides, insecticides, algicides, molluscicides, miticides and rodenticides; antimicrobial agents, germicides, antibiotics, antibacterials, antivirals, antifungals, antiprotozoals and antiparasites and any combination thereof.

It is a further object of this invention to disclose such a liquid or liquid concentrate, wherein said liquid (or said liquid reconstituted from said liquid concentrate) is adapted to be served from a dispenser.

It is a further object of this invention to disclose such a liquid or liquid concentrate, wherein said dispenser is chosen from the group consisting of soda fountain, vending machine, and carbonated beverage dispenser.

It is a further object of this invention to disclose such a liquid or liquid concentrate, wherein said liquid is reconstituted within said dispenser from a concentrate and at least one diluent.

It is a further object of this invention to disclose such a liquid or liquid concentrate, wherein said liquid or beverage concentrate is at least partially produced by a continuous flow process.

It is a further object of this invention to disclose such a liquid or liquid concentrate, wherein said liquid is at least partially produced by a batch process.

The liquid concentrate according to claim 78, wherein said lumen of said container is characterized by a flowability of more than an effective measure according to ASTM standard D6103.

### BRIEF DESCRIPTION OF THE DRAWING

The invention herein disclosed is described with reference to the drawing, wherein

FIG. 1 presents a graph comparing the concentration of yeast as a function of time in a sample of NESTEA that was treated according to the method herein disclosed with the concentration of yeast in a control sample.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the FIGURE and described in the specification, but only as indicated in the accompanying claims, with the proper scope determined only by the broadest interpretation of said claims.

As used herein, the term “particulate matter” refers hereinafter to one or more members of a group consisting of nano-powders, micrometer-scale powders, fine powders, free-flowing powders, dusts, aggregates, particles having an average diameter ranging from about 1 nm to about 1000 nm, or from about 1 mm to about 25 mm.

As used herein, the term “about” refers hereinafter to ±20% of the defined measure.

As used herein, the term “medication” refers to any substance intended to improve the health of, or reduce the risk of disease in, an individual to whom it is administered. According to this definition, medications include substances intended for ingestion as well as substances intended for external application. Non-limiting examples of medications include drugs; vitamin supplements; mineral supplements; herbal and other nutritional supplements; solutions (e.g. glucose or saline) intended for intravenous administration to hospital patients; and creams, salves, lotions, etc. intended for alleviation of or cure of diseases and other conditions of the skin.

As used herein, with reference to concentrations of substances within a liquid the term “maximum set by law” refers to the upper limit to the concentration that is permitted by the legal authority or authorities in the jurisdiction in which the liquid is being sold or distributed. The “maximum set by law” may refer to law, statute, regulation, case law, or any other means by which a legal authority promulgates the maximum concentration of a substance within a liquid. In the case of sale or distribution in a locality in which overlapping jurisdictions set different upper limits, as used herein, the term “maximum set by law” refers to the lowest of these.

As used herein, the term “liquid concentrate” refers to any liquid, semi-liquid, gel, frozen liquid, or other substance that contains at least some of the constituents of a liquid at a concentration higher than that at which they are found when the liquid is in the final form used in practice by the typical end user, and is reconstituted to generate the liquid at some point prior to its consumption or use. While concentrates are typically reconstituted to generate the liquid at least partially by dilution, the term as used here in is intended to include any material that meets the above definition, even if the process of reconstitution involves steps in addition to dilution with water (e.g., as non-limiting examples, warming or addition of substances in addition to water). Furthermore, while concentrates are typically produced by physical concentration of a dilute solution and/or suspension, the term is used independent of the means by which such concentrates are produced. Such concentrates include, but are not limited to, beverage concentrates stored at room temperature, syrups, and frozen beverage concentrates.

As used herein, the term “completely filled,” when used with reference to a container, refers to a state in which the container is filled with a substance to the degree that the substance within the container contacts at least a part of every inner surface enclosing the substance (e.g., the bottom of the container, the walls, and the inner surface of any removable closure or closures). In a case in which any part of the container comprises a secondary surface (e.g. a lining, coating, seal, etc.), that might prevent the substance contained within from contacting an inner surface of the container itself, the term “completely filled” is to be understood to refer to contact between the substance contained and the secondary surface.

As used herein, the term “beverage-spoiling microorganism” refers to any microorganism capable of increasing the rate of spoilage of a product, decreasing the palatability of a product, decreasing the quality of at least one organoleptic parameter associated with a product, causing an illness in a mammal that ingests or applies a product, or producing a substance that can cause detrimental effects to the health of a mammal that ingests or applies a product. By this definition, beverage-spoiling microorganisms include (but are not limited to) those species of bacteria, viruses, yeasts, microbes, algae, molds, and fungi that are capable of at least one of the actions described above, and further include (but are not limited to) spoilage organisms. The action of a “beverage-spoiling mechanism” as herein defined is not limited to action within a beverage or foodstuff. The action of such microorganisms may occur within or upon any product susceptible to having its rate of spoilage increased or shelf life decreased due to the action of microorganisms. Non-limiting examples of products the shelf life of which can be limited by the action of beverage-spoiling microorganisms, and hence products upon which the method disclosed herein can be applied, include beverages; other foodstuffs; animal feeds; medications; creams, lotions, ointments, etc. intended for external application; and cosmetics.

As used herein, the term “decreasing the quality of at least one organoleptic parameter” refers to altering any organoleptic parameter (non-limiting examples include smell, taste, appearance, feel in the mouth, viscosity, texture, etc.) in such a way as to make the prospect of ingesting the foodstuff less attractive (relative to the identical foodstuff unaffected by the pathogen) to a typical consumer.

As used herein, the term “pathogen” refers to any microorganism or virus capable of causing a disease in, or producing a substance that can cause detrimental effects to the health of, a mammal.

As used herein, when referring to a concentration of pathogens or beverage-spoiling microbes as defined above, the term “substantially free” refers to a concentration below the minimum necessary for the effects described above to occur in a consumer or a beverage in its end-use packaging. When used to describe the concentration of a substance in solution, the term refers either to a concentration that is typical of a solution to which substance has not been deliberately added, or to a concentration that is unaltered after undergoing a given process that does not involve the deliberate addition of the substance. According to this definition, a solution will be “substantially free” of the substance even in the presence of inadvertent environmental contamination.

As used herein, when referring to a beverage, the term “shelf life” refers to the time period that a product may be stored before reaching its end point. Non-limiting examples of measures of the decline in quality that cause the product to reach its end point include decline in palatability to the point that the beverage becomes undrinkable for the average consumer or unsalable to the average consumer, increase in levels of spoilage microbes above a predetermined standard, etc. As used herein, the term is used as defined in, and the sensory evaluation methods by which the end of a product's shelf life is determined are as described in, ASTM standard E2454-05.

As used herein, the term “extended shelf life” refers to a shelf life that is longer by a statistically significant amount than that of an otherwise identical product that has not undergone any treatment that will extend its shelf life.

It is herein acknowledged that the present invention is directed to providing a liquid or liquid concentrate with an extended shelf life; in preferred embodiments, the liquid or liquid concentrated is substantially free of beverage spoiling microorganisms.

It is further herein acknowledged that the present invention is directed to providing the aforementioned liquid adapted to become substantially free of beverage spoiling microorganisms after a predetermined period of time following treatment with a bioactive material.

It is also in the scope of the invention wherein the bioactive material as defined in any of the present invention refers inter alia to an active material or matrix which enables the container with active means to absorb, eliminate, reduce toxicity, decontaminate, or bind hazardous or toxic materials and microorganisms (fungi, bacteria, viruses etc), undesired products, such as fermentation byproducts, particulate matter, aggregates etc.

It is also in the scope of the invention wherein the liquid is a beverage, foodstuff, medication, or cosmetic, or at least partially contained within a foodstuff, medication, or cosmetic. It is also in the scope of the invention wherein the liquid concentrate is a concentrate as defined above that can be reconstituted by addition of an appropriate diluent into a beverage, foodstuff, medication, or cosmetic.

The detailed description and examples presented below emphasize the use of the method herein disclosed for treatment of a beverage or beverage concentrate in order to produce an extended shelf-life beverage or beverage concentration (in preferred embodiments, one that is substantially free of beverage-spoiling microorganisms). One skilled in the art will understand, however, that the method disclosed herein can be used, mutatis mutandis, to treat any liquid that is susceptible to spoilage or reduction of shelf life due to the action of beverage-spoiling microorganisms. Specific references to treatment of and production of beverages are thus to be taken as exemplary and non-limiting.

In a preferred embodiment of the invention disclosed herein, a liquid and/or liquid concentrate is disclosed in which the concentration of microorganisms is maintained indefinitely below 10² ml⁻¹ for as long as the product remains in its original container. A biocidic material is incorporated into the container into which the liquid is placed, and contact with the biocidic material reduces or eliminates microbial infestation without any need for pasteurization or addition of a preservative or antimicrobial substance.

Non-limiting examples of beverage-spoiling microorganisms infestation by which can be reduced or eliminated according to the method herein disclosed include Gram-positive microorganisms including, but not limited to, Staphylococcus aureus, Methicillin-resistant Staphylococcus aureus (MRSA), Staphylococcus saprophyticus, Staphylococcus epidermidis, Enterococcus faecalis, Vancomycin-resistant enterococcus, Lactobacillus para paracasei, Lactobacillus lactis, Lactobacillus plantarum, Bacillus brevis, Bacillus atrophaeus, and Alicyclobacillus TAB (Thermophilic Acidophilic bacteria); Gram-negative microorganisms including, but not limited to, Pseudomonas aeroginosa, Escherichia coli, Klebsiella pneumoniae, Enterobacter cloacae, Proteus mirabilis, Acetobacter aceti, Gluconobacter oxydans, Citrobacter koseri Frederiksen (former-Citrobacter diversus), Salmonella enteritidis; and fungi including, but not limited to, Candida albicans, Aspergillus niger, Saccharomyces serevisiae, Schysosaccharomyces pombe, Zygosaccharomyces Penicillium glabrum, Byssochlamis fulva, Aspergillus ochraceus, and Penicillium roquefort. Liquids (especially beverages) produced by treatment by the method herein disclosed can therefore be expected to be free of inter alia any or all of the above-listed microorganisms.

In a more preferred embodiment of the invention, the biocidic material used to produce the liquid comprises at least one charged polymer. In the most preferred embodiments, this charged polymer is characterized, when in contact with a water-containing environment such as that of a beverage, as carrying strongly acid and/or strongly basic functional groups; having a pH of less than about 4.5 or greater than about 8.0; being capable of generating an electrical potential within the confined volume of said cell sufficient to disrupt effectively the pH homeostasis and/or electrical balance within said confined volume of said cell; and being in a form chosen from the group consisting of (i) H⁺ and (ii) OH⁻. The materials and compositions of the current invention include but not limited to all materials and compositions disclosed in PCT application No. PCT/IL2006/001263, which is incorporated in its entirety by reference. In addition to ionomers disclosed in PCT/IL2006/001263, other ionomers can be used for production of beverages according to the current invention. These may include, but certainly not limited to, for example: sulfonated silica, sulfonated polythion-ether sulfone (SPTES), sulfonated styrene-ethylene-butylene-styrene (S-SEBS), polyether-ether-ketone (PEEK), poly (arylene-ether-sulfone) (PSU), Polyvinylidene Fluoride (PVDF)-grafted styrene, polybenzimidazole (PBI) and polyphosphazene, proton-exchange membrane made by casting a polystyrene sulfonate (PSS) solution with suspended micron-sized particles of cross-linked PSS ion exchange resin.

It is also in the scope of the invention wherein the bioactive material as defined in any of the present invention comprises a mixture of at least one volatile component and at least one non-volatile component. The bioactive material may undergoes film formation by loss of part of the volatile component. The volatile component may comprise a volatile liquid component. The volatile liquid component may comprise a solvent, a thinner, a diluent, or a combination thereof. The non-volatile component may comprise a binder, a colorant, a plasticizer, a coating additive, or a combination thereof. The film formation may occur by crosslinking of a binder. The film formation may occur by crosslinking of a plurality of binders. The film formation may occur by irradiating the coating. The coating may produce a self-cleaning film. The coating may produce a temporary film. The temporary film may have a poor resistance to a coating remover. The temporary film may have a poor abrasion resistance, a poor solvent resistance, a poor water resistance, a poor weathering property, a poor adhesion property, a poor microorganism and/or biological resistance property, or a combination thereof. The coating may be a non-film forming coating. The non-film forming coating may comprise a non-film formation binder. The non-flm forming coating may comprise a coating component in a concentration that is insufficient to produce a solid film. The coating component may comprise a binder that contributes to thermoplastic film formation. The coating component may contribute to thermosetting film formation. The coating component may comprise a binder, catalyst, initiator, or combination thereof. The coating component may have a concentration of 0% or more. The coating may comprise a water-borne coating. The water-borne may comprise a latex coating. The water-borne coating may be provided in a density of 1.20 kg/L to 1.50 kg/L. The coating may comprise a solvent-borne coating. The solvent-borne coating may be provided in a density of 0.90 kg/L to 1.2 kg/L. The bioactive material may also comprise a binder, a liquid component, a colorant, an additive, or a combination thereof. The binder is selected in a non-limiting manner from a thermoplastic binder, a thermosetting binder, or a combination thereof. The binder may comprise an oil-based binder; a polyester resin, such as a hydroxy-terminated polyester or a carboxylic acid-terminated polyester; a urethane, an amino resin, or a combination thereof; a modified cellulose, such as a cellulose ester or a nitrocellulose; an amino binder, an acrylic binder, a urethane binder, or a combination thereof; a polyamide; an epoxide; an amino resin; acrylic binder, an alkyd resin, a polyester binder, or a combination thereof. the urethane binder may comprise a polyol, an amine, an epoxide, a silicone, a vinyl, a phenolic, a triacrylate, or a combination thereof. A phenolic resin may comprise an alkyd resin, an amino resin, a blown oil, an epoxy resin, a polyamide, a polyvinyl resin, or a combination thereof.

The epoxy resin mat comprise an amino resin, a phenolic resin, a polyamide, a ketimine, an aliphatic amine, or a combination thereof, a cycloaliphatic epoxy binder; a polyol; a polyhydroxyether binder; an epoxide, a polyurethane comprises an isocyanate moiety, an amino resin, or a combination thereof. The acrylic resin may comprise an epoxide, a polyurethane comprises an isocyanate moiety, an amino resin, or a combination thereof. The binder may comprise a polyvinyl binder. The binder may comprise a rubber resin, such as chlorinated rubber resin, a synthetic rubber resin, or a combination thereof. The binder may comprise polysulfide binder. The binder may comprise silicone binder. The bioactive material may comprise an effective measure of a plasticizer. The plasticizer is selected in a non-limiting manner form a group consisting inter alia of comprises di(2-ethylhexyl) azelate; di(butyl) sebacate; di(2-ethylhexyl) phthalate; di(isononyl) phthalate; dibutyl phthalate; butyl benzyl phthalate; di(isooctyl) phthalate; di(idodecyl) phthalate; tris(2-ethylhexyl) trimellitate; tris(isononyl) trimellitate; di(2-ethylhexyl) adipate; diisononyl) adipate; acetyl tri-butyl citrate; an epoxy modified soybean oil; 2-ethylhexyl epoxytallate; isodecyl diphenyl phosphate; tricresyl phosphate; isodecyl diphenyl phosphate; tri-2-ethylhexyl phosphate; an adipic acid polyester; an azelaic acid polyester; a bisphenoxyethylformal, or a combination thereof. The plasticizer may comprise an adipate, an azelate, a citrate, a chlorinated plasticizer, an epoxide, a phosphate, a sebacate, a phthalate, a polyester, a trimellitate, or a combination thereof. The bioactive material may comprise a colorant. The colorant is selected ion a non-limiting manner form a group consisting inter alia of a pigment, a dye, UV blocker or a combination thereof. The color property pigment may comprise a black pigment, a brown pigment, a white pigment, a pearlescent pigment, a violet pigment, a blue pigment, a green pigment, a yellow pigment, an orange pigment, a red pigment, a metallic pigment, a cell-based particulate material, or a combination thereof; aniline black; anthraquinone black; carbon black; copper carbonate; graphite; iron oxide; micaceous iron oxide; manganese dioxide, azo condensation, metal complex brown; antimony oxide; basic lead carbonate; lithopone; titanium dioxide; white lead; zinc oxide; zinc sulphide; titanium dioxide and ferric oxide covered mica, bismuth oxychloride crystal, dioxazine violet, carbazole Blue; cobalt blue; indanthrone; phthalocyanine blue; Prussian blue; ultramarine; chrome green; hydrated chromium oxide; phthalocyanine green; anthrapyrimidine; arylamide yellow; barium chromate; benzimidazolone yellow; bismuth vanadate; cadmium sulfide yellow; complex inorganic color; diarylide yellow; disazo condensation; flavanthrone; isoindoline; isoindolinone; lead chromate; nickel ado yellow; organic metal complex; yellow iron oxide; zinc chromate; perinone orange; pyrazolone orange; anthraquinone; benzimidazolone; BON arylamide; cadmium red; cadmium selenide; chrome red; dibromanthrone; diketopyrrolo-pyrrole; lead molybdate; perylene; pyranthrone; quinacridone; quinophthalone; red iron oxide; red lead; toluidine red; tonor; naphthol red; aluminum flake; aluminum non-leahing, gold bronze flake, zinc dust, stainless steel flake, nickel flake, nickel powder, or a combination thereof.

It is also in the scope of the invention wherein the bioactive material as defined in any of the present invention refers inter alia to a material which acts in an opposite manner as compared to a biocide, i.e., inoculates, enhances, stabilizes, accelerates, differentiates or otherwise increase the growth, accumulation and/or survive of predetermined microorganism specie or species (‘probiotic’ or ‘good bacteria’ of the digestion system, for example) within the container.

It is also in the scope of the invention wherein the bioactive material as defined in any of the present invention refers inter alia to an active material or matrix which enables the container with which active properties, in an opposite manner as compared to any commercial containers which nothing than a passive vessel with accommodates a given content, with no positive interaction with the content or a specified component of the content. It is hence in the scope of the invention wherein the bioactive material as defined in any of the present invention also refers to indicators, labels, detectors, signal emitters, etc suitable for indicating (directly or indirectly) the condition of the container and the material contained therein. The indication is selected, in a non-limiting manner, e.g., from a group consisting tamper-proof and other open/close conditions, oxidation state, pressure, temperature, acidity, specific concentration of a preset material or composition (such as sugar of living microorganism), protein and/or enzymes presence or activity, fat content etc.

Without being bound by theory, it is believed that the mode of action of the charged polymer is to disrupt the cellular metabolism of the objectionable microorganisms by disrupting the pH within the cell while leaving the pH of the environment surrounding the cell essentially unchanged. This particular embodiment has a number of advantages. Since it works by creating a pH gradient, there is no necessity for physical contact with the cell to be killed. Thus, the biocidic material need not be on the surface of the container, although in some embodiments, it will be. It is sufficient to dispose it within the container in such a way that it will have contact, direct or indirect, with the aqueous environment within the container. Thus, incorporating the biocide into the material of the container, either during the formation of the material or the production of the container itself, is a possible means for creating the pH gradient.

Contacting (directly on the surface or indirectly through the aqueous medium) a living cell with the charged polymer kills the cell in a time period and with an effectiveness depending on the pH of the polymer, the mass of polymer contacting the cell, the specific functional group(s) carried by the polymer, and the cell type. The cell is killed by a titration process where the charged polymer causes a pH change within the cell. The cell is often effectively killed before membrane disruption or cell lysis occurs. The charged polymer can kill cells without directly contacting the cells if contact is made through a coating or membrane which is permeable to water and to H⁺ and OH⁻ ions, but not to other ions or molecules. Such a coating also serves to prevent changing the pH of the charged polymer or of the solution surrounding the target cell by diffusion of counterions to the polymer's functional groups.

Another advantageous property of the biocidic material used in this embodiment is that it is essentially passive in its action. As such, it will leach no more than traces (typically less than 1 ppm) of material into the beverage. In preferred embodiments of the invention, the beverage is substantially free of leached substances derived from said treatment capable of affecting any parameter selected from the group consisting of pH, chemical parameter, biological parameter, viscosity, density, ionic concentration, conductivity, taste, appearance, odor, texture, feel in the mouth, carbon dioxide concentration, oxygenation, and any combination of the above.

Not only does this lack of leaching make the substance safer than similar biocides that release material into the environment (e.g. metal ions or antibiotics), but it guarantees that the organoleptic properties of the beverage, most significantly its taste, odor, and appearance, will be preserved. Thus, in preferred embodiments of the invention, the beverage is provided without additional preservatives, without having undergone pasteurization, and without any necessity for hot filling.

It is also in the scope of the invention wherein an insoluble polymer, ceramic, gel, resin or metal oxide carrying strongly acid (e.g. sulfonic acid or phosphoric acid) or strongly basic (e.g. quaternary or tertiary amines) functional groups (or both) of a pH of about <4.5 or about >8.0 is disclosed. The functional groups throughout the charged polymer are accessible to water, with a volumetric buffering capacity of about 20 to about 100 mM H⁺/l/pH unit, which gives a neutral pH when placed in unbuffered water (e.g., about 5<pH> about 7.5) but which kills living cells upon contact.

In a preferred embodiment of the invention, the biocidic material coats part of the inner surface of the container in which the liquid is stored. Since spoilage organisms naturally migrate either to the upper part or to the lower part of the beverage while it sits in its container, in a preferred embodiment of the invention, the biocidic material is incorporated into only a portion of the container (i.e. around just the top and bottom). The liquid is left in contact with the biocidic material for a predetermined length of time, typically 3-7 days. After this time, it is substantially free (<10² ml⁻¹ in typical embodiments) of organisms of interest, and will remain so indefinitely as long as least part of the enclosed volume of beverage remains in contact with the biocidic material. Thus, in alternative embodiments of the invention, it is sufficient to incorporate the biocide into only one portion of the container (i.e. around just the top or around just the bottom), and after a predetermined period of time, to invert the container for a second predetermined period of time. As a non-limiting example, if the top portion of the container is coated, during the first period, those organisms that have migrated to the upper portion of the container will be killed; then, after the container is inverted, those organisms that migrate to the lower portion of the container will contact the biocide and be killed.

The biocidic material need not be disposed specifically within or on the material out of which the container is made. It may be introduced, by way of non-limiting example, in the form of an insert or lining, or in or on any surface that comes in contact with the beverage while it is inside the container.

In another preferred embodiment of the invention, especially for such uses as a beverage in which the container is provided to the consumer completely filled, the biocidic material is incorporated into, or disposed as a layer on the inner surface of, at least part of the closure of the container (lid, cap, stopper, seal, etc.). As with the previous embodiments, this inner surface can be, e.g., an insert or a liner rather than the inner surface of the closure itself. The container is filled, the closure applied, and the beverage allowed to stand for a predetermined period of time (typically 3-7 days). The container is then inverted and allowed to stand for a second predetermined period of time. At the end of this second period of time, the beverage will be substantially pathogen free (i.e., it will be a beverage as disclosed in the present invention).

The beverage as disclosed in the present invention is characterized by at least one organoleptic condition (non-limiting examples include taste, odor, appearance, and texture). In a preferred embodiment, this condition remains essentially unchanged from before the treatment with the biocide to after the treatment; in other words, in a preferred embodiment, the beverage as disclosed in the present invention will be essentially indistinguishable from the beverage as freshly-prepared, and will remain so indefinitely. In one embodiment, for a given organoleptic condition, the difference before the treatment and after the treatment will be less than about 30%. In a preferred embodiment of the invention, difference between said first predetermined organoleptic condition obtained prior to said treatment and said second predetermined organoleptic condition obtained after said treatment is less than about 5%.

Because the methods of treatment disclosed in the present invention can be tailored to a particular substance, and in preferred embodiments leave the properties of the substance itself substantially unaffected, any kind of liquid can be produced by treatment with the method herein disclosed. For example, non-limiting examples of beverages disclosed in the present invention include carbonated beverages, sodas, water, mineral water, soda water, flavoured beverages, non carbonated beverages, still beverages, ready-to-drink beverages, beverages containing alcohol, sweetened beverages, diet beverages, beverages with added caramel, beverages with artificial citrus flavourings, beverages with artifical cola flavourings, artificially sweetened beverages, naturally sweetened beverages, energy beverages, naturally sweetened beverages, sugar sweetened beverages, draft beverages, fruit juice based beverages, natural beverages, natural fruit beverages, freshly squeezed fruit beverages, vegetable juice based beverages, canned beverages, bottled beverages, refrigerated beverages, tea based beverages, iced tea, brewed tea, carbonated water with additional flavoring, carbonated water with fruit flavoring, milk based beverages, sterilised beverages, and pasteurised beverages.

The liquid can be introduced into its container by any means known in the art, either aerobic or anaerobic. Methods such as hot filling that degrade the quality of the liquid are not necessary, but are not excluded.

The liquid need not be provided in a container. As a non-limiting example, in additional embodiments of the invention, a beverage is provided in a dispenser, wherein the biocidic material is disposed within the dispenser itself. Non-limiting examples of dispensers for beverages include soda fountains, vending machines that drop an empty cup into a receptacle and then fill the cup, and soft drink dispensers of the type found in many restaurants and convenience stores in which a cup is placed by the consumer under a spigot that dispenses a particular kind of beverage.

As mentioned above, many consumer products that have end uses as liquids (particularly beverages) are either reconstituted from, or sold in the form of, a concentrate. All of the embodiments of liquids discussed above have parallel embodiments of liquid concentrates that are substantially free of beverage-spoiling microbes. If the concentrate is contacted with a biocide as disclosed above for a beverage, an extended shelf life beverage concentrate (in preferred embodiments, one that is substantially free of beverage-spoiling microorganisms) will be obtained. This concentrate can, like the analogous beverage, be stored indefinitely without any significant amount of growth of spoilage or disease-causing organisms. Upon reconstitution (e.g. by dilution with water or carbonated water), the beverage thus produced by the mixture of the beverage concentrate and the diluent will be a beverage as well. Thus, the present invention provides another means for producing a beverage, namely, by reconstitution of a beverage concentrate.

Note that in additional embodiments, the production of the beverage can take place within the dispensing unit itself, not only by dilution of a pre-existing beverage concentrate, but by treatment by the biocidic material within the dispenser itself. The biocide can be incorporated into or disposed upon at least a portion of the surface contacted by the concentrate (in cases in which the beverage is produced by dilution of a concentrate supplied to the dispenser), leading to in situ creation of a beverage concentrate from a given concentrate, and then a beverage from the beverage concentrate. This contact can occur before dilution/reconstitution, during, or after the production of the beverage.

It is further acknowledged in this respect that while many of the embodiments described above discuss the liquid in terms of its end-use container or dispenser, there is no requirement that the biocidic material be disposed specifically in or upon an end-use container or dispenser. As long as the liquid contacts the biocidic material at some point in its manufacture as described above, it will necessarily be an extended shelf life liquid, although it may be necessary to guarantee the sterility, via means well-known in the art, of other machinery involved in the production process, in order to guarantee that the liquid will still be substantially free of beverage-spoiling microorganisms when it is placed into its end-use container.

In additional embodiments of the invention, a method is disclosed for regenerating the biocidic properties of biocidic materials disposed in the container in which the beverage is stored. The method comprises a step chosen from the group consisting of (a) regenerating said packaging's proton absorbing and/or releasing capacity; (b) regenerating said packaging's buffering capacity; and (c) regenerating the proton conductivity of said packaging. It is acknowledged in this respect that regeneration of the biocidic properties of the biocidic materials disposed in the container is especially useful for those cases in which the container is an intermediate container in the production of the beverage, or a container intended for multiple fillings (e.g. metal containers for beverage concentrates), or for containers intended for recycling.

In additional embodiments, the liquid is adapted for storage and/or transportation at ambient temperature.

In additional embodiments, the liquid is adapted for storage and/or transportation under conditions of substantially less refrigeration than those required to prevent spoilage and/or change in said at least one organoleptic condition in an otherwise identical beverage that has not undergone said treatment with said bioactive substance.

In additional embodiments, the liquid is provided wherein the rate of growth of the population of and/or the concentration of pathogens and/or beverage-spoiling microbes within a predetermined volume of said liquid is independent of the temperature at which said liquid is stored.

In additional embodiments, the liquid is provided wherein the rate of growth of the population of and/or the concentration of pathogens and/or beverage-spoiling microbes within a predetermined volume of said liquid is, for a predetermined period of time following said treatment by a bioactive material, independent of the temperature at which said liquid is stored.

In additional embodiments, the liquid is provided wherein the rate of growth of the population of and/or the concentration of pathogens and/or beverage-spoiling microbes within a predetermined volume of said liquid maintained under a predetermined temperature protocol is slower than the rate of growth of the population of and/or the concentration of pathogens and/or beverage-spoiling microbes within an equal volume of a second beverage maintained under the same predetermined temperature protocol, said second beverage otherwise identical to said liquid except for said treatment with said bioactive material.

In additional embodiments, the extended shelf life beverage is adapted for storage and/or transportation at ambient temperature.

In additional embodiments, the extended shelf life beverage is adapted for storage and/or transportation under conditions of substantially less refrigeration than those required to prevent spoilage and/or change in said at least one organoleptic condition in an otherwise identical beverage that has not undergone said treatment with said bioactive substance.

In additional embodiments, the extended shelf life beverage is provided wherein the rate of growth of the population of and/or the concentration of pathogens and/or beverage-spoiling microbes within a predetermined volume of said extended shelf life beverage is independent of the temperature at which said liquid is stored.

In additional embodiments, the extended shelf life beverage is provided wherein the rate of growth of the population of and/or the concentration of pathogens and/or beverage-spoiling microbes within a predetermined volume of said extended shelf life beverage is, for a predetermined period of time following said treatment by a bioactive material, independent of the temperature at which said extended shelf life beverage is stored.

In additional embodiments, the extended shelf life beverage is provided wherein the rate of growth of the population of and/or the concentration of pathogens and/or beverage-spoiling microbes within a predetermined volume of said extended shelf life beverage maintained under a predetermined temperature protocol is slower than the rate of growth of the population of and/or the concentration of pathogens and/or beverage-spoiling microbes within an equal volume of a second beverage maintained under the same predetermined temperature protocol, said second beverage otherwise identical to said extended shelf life beverage except for said treatment with said bioactive material.

### EXAMPLES

The following non-limiting examples summarize the results of trials demonstrating the efficacy and usefulness of the present invention.

### Example 1

### Yeast and Mold in Nestea

250 ml PET bottles were coated internally with active coating based on ion exchange resin mixtures (IERM) and Matrix prepared in a form of thin sheet by heat forming.

The active mixtures consisted of a mixed bed ion exchange resin.

The bottom part of the bottle was covered with a sheet of 0.8-1.0 mm thickness 3 cm from the bottom, as shown in the following table.

| | | Active | | | | weight of |
|---|---|---|---|---|---|---|
| | | material | Total a.m | A.M in | place- | strip/ |
| materials | type | [gr/%] | [g/%] | sheet | ment | circle |
| IERM | sand- | 0.3 | 0.73 | 18% | 3 cm | 3.2 gr |
| | wich | | | | from | |
| | | | | | bottom | |
| IERM | | 0.43 | | 18% | bottom | 4.8 gr |

Coated bottles were filled with NESTEA without preservatives purchased from a supermarket. The Nestea was inoculated with either a yeast cocktail, a mold cocktail or a mixed cocktail of all. For control, bottles coated with Matrix and uncoated bottles were used. The bottles were incubated at 30° C. Samples (n=3) were taken after 3, 7, 14, 21 and 28 days and plated on Malt extract agar using the pour plate method. pH was also measured at the same time points. The plates were incubated at 30° C. and counted after 24-48 hours.

The results of these tests are summarized in Tables 1-3 below.

TABLE 1
Yeast viable counts in test bottles with Nestea.

| | | Time zero | | 3 days | | 7 days | | 14 days | | 21 days | | 28 days | |
|---|---|---|---|---|---|---|---|---|---|---|---|---|---|
| | Tube no. | CFU/ml | pH | CFU/ml | pH | CFU/ml | pH | CFU/ml | pH | CFU/ml | pH | CFU/ml | pH |
| ctrl | 1 | 1.5E+04 | 3.5 | 2.3E+06 | 3.5 | 1.6E+06 | 3.5 | 2.0E+04 | 3.5 | 2.8E+06 | 3.5 | 2.9E+05 | 3.5 |
| | 2 | | 3.5 | 3.8E+06 | 3.5 | 2.5E+06 | 3.5 | 9.0E+05 | 3.5 | 1.5E+06 | 3.5 | 2.8E+05 | 3.5 |
| | 3 | | 3.5 | 1.8E+06 | 3.5 | 3.4E+06 | 3.5 | 2.0E+06 | 3.5 | 2.5E+06 | 3.5 | 1.1E+06 | 3.5 |
| EVA | 1 | 1.5E+04 | 3.5 | 2.6E+06 | 3.5 | 1.9E+06 | 3.5 | | | | | | |
| | 2 | | 3.5 | 2.1E+06 | 3.5 | 1.2E+06 | 3.5 | | | | | | |
| | 3 | | 3.5 | 2.2E+06 | 3.5 | 1.1E+06 | 3.5 | | | | | | |
| mix | 1 | 1.5E+04 | 3.5 | 8.2E+01 | 3.5 | <1 | 3.5 | <1 | 3.5 | <1 | 3.5 | <1 | 3.2 |
| | 2 | | 3.5 | 2.6E+02 | 3.5 | <1 | 3.5 | <1 | 3.5 | <1 | 3.5 | <1 | 3.3 |
| | 3 | | 3.5 | 8.0E+01 | 3.5 | <1 | 3.5 | <1 | 3.5 | <1 | 3.5 | <1 | 3.2 |

[symbol]

TABLE 2
Mold viable counts in test bottles with Nestea.

| | | Time zero | | 3 days | | 7 days | | 14 days | | 21 days | | 28 days | |
|---|---|---|---|---|---|---|---|---|---|---|---|---|---|
| | Tube no. | CFU/ml | pH | CFU/ml | pH | CFU/ml | pH | CFU/ml | pH | CFU/ml | pH | CFU/ml | p [symbol] |
| [symbol] | 1 | 1.1E+03 | 3.5 | 3.0E+04 | 3.5 | 2.5E+05 | 3.5 | 1.0E+06 | 3.3 | 1.0E+06 | 3.3 | 9.0E+05 | [symbol] |
| | 2 | | 3.5 | 1.3E+05 | 3.5 | 1.6E+06 | 3.5 | 8.0E+05 | 3.3 | 8.0E+05 | 3.3 | 8.0E+05 | [symbol] |
| | 3 | | 3.5 | 1.3E+05 | 3.5 | 2.1E+05 | 3.5 | 1.2E+06 | 3.3 | 1.2E+06 | 3.3 | 5.0E+05 | [symbol] |
| [symbol] | 1 | 1.1E+03 | 3.5 | 1.2E+05 | 3.5 | 7.5E+06 | 3.5 | | | | | | |
| | 2 | | 3.5 | 7.0E+04 | 3.5 | 4.0E+05 | 3.5 | | | | | | |
| | 3 | | 3.5 | 2.0E+04 | 3.5 | 2.0E+04 | 3.5 | | | | | | |
| [symbol] e | 1 | 1.1E+03 | 3.5 | <1 | 3.5 | <1 | 3.5 | <1 | 3.5 | <1 | 3.5 | <1 | [symbol] |
| | 2 | | 3.5 | <1 | 3.5 | <1 | 3.5 | <1 | 3.5 | <1 | 3.5 | <1 | [symbol] |
| | 3 | | 3.5 | <1 | 3.5 | <1 | 3.5 | <1 | 3.5 | <1 | 3.5 | <1 | [symbol] |

[symbol]

indicates data missing or illegible when filed

TABLE 3
Mix of yeast and mold in Nestea

| | Time zero | | 3 days | | 7 days | | 14 days | | 21 days | | 28 days | |
|---|---|---|---|---|---|---|---|---|---|---|---|---|
| Tube no. | CFU/ml | pH | CFU/ml | pH | CFU/ml | pH | CFU/ml | pH | CFU/ml | pH | CFU/ml | p [symbol] |

yeast

| | | | | | | | | | | | | | |
|---|---|---|---|---|---|---|---|---|---|---|---|---|---|
| [symbol] l | 1 | 2.3E+03 | 3.5 | 1.9E+06 | 3.5 | 2.2E+06 | 3.5 | 6.0E+05 | 3.5 | 2.2E+06 | 3.3 | 9.0E+05 | [symbol] |
| | 2 | | 3.5 | 1.9E+06 | 3.5 | 2.6E+06 | 3.5 | 6.4E+06 | 3.5 | 2.6E+06 | 3.3 | 7.0E+05 | [symbol] |
| | 3 | | 3.5 | 2.1E+06 | 3.5 | 2.1E+06 | 3.5 | | | 2.8E+06 | 3.3 | 1.3E+06 | [symbol] |
| [symbol] A | 1 | 2.3E+03 | 3.5 | 2.0E+06 | 3.5 | 1.9E+06 | 3.5 | | | | | | |
| | 2 | | 3.5 | 4.8E+05 | 3.5 | 1.9E+06 | 3.5 | | | | | | |
| | 3 | | 3.5 | 1.1E+06 | 3.5 | 3.6E+05 | 3.5 | | | | | | [symbol] |
| [symbol] ve | 1 | 2.3E+03 | 3.5 | 6.3E+02 | 3.5 | 9.2E+02 | 3.5 | 3.3E+01 | 3.3 | 4.1E+02 | 3.3 | 1.2E+03 | [symbol] |
| | 2 | | 3.5 | <1 | 3 | <1 | 3 | <1 | 3.3 | <1 | 3.3 | <1 | [symbol] |
| | 3 | | 3.5 | <1 | 3.5 | <1 | 3.5 | <1 | 3.3 | <1 | 3.3 | <1 | [symbol] |

mold

| | | | | | | | | | | | | | |
|---|---|---|---|---|---|---|---|---|---|---|---|---|---|
| [symbol] l | 1 | 1.3E+03 | 3.5 | <10 | 3.5 | 4.0E+04 | 3.5 | 6.0E+05 | 3.5 | 1.3E+06 | 3.3 | 9.0E+05 | [symbol] |
| | 2 | | 3.5 | 6.0E+04 | 3.5 | 4.0E+04 | 3.5 | 1.1E+06 | 3.5 | 4.0E+05 | 3.3 | 8.0E+05 | [symbol] |
| | 3 | | 3.5 | 3.0E+02 | 3.5 | 3.0E+04 | 3.5 | | | 9.0E+05 | 3.3 | 4.0E+05 | [symbol] |
| [symbol] A | 1 | 1.3E+03 | 3.5 | 3.0E+03 | 3.5 | 1.4E+05 | 3.5 | | | | | | |
| | 2 | | 3.5 | 2.0E+03 | 3.5 | 1.1E+06 | 3.5 | | | | | | |
| | 3 | | 3.5 | 2.0E+01 | 3.5 | 9.0E+04 | 3.5 | | | | | | |
| [symbol] ve | 1 | 1.3E+03 | 3.5 | <1 | 3.5 | <1 | 3.5 | <1 | 3.3 | <1 | 3.3 | <1 | [symbol] |
| | 2 | | 3.5 | <1 | 3 | <1 | 3 | <1 | 3.3 | <1 | 3.3 | <1 | [symbol] |
| | 3 | | 3.5 | <1 | 3.5 | <1 | 3.5 | <1 | 3.3 | <1 | 3.3 | <1 | [symbol] |

[symbol]

indicates data missing or illegible when filed

As we can see from the results there was at least a 4 log reduction in the yeast concentration and there was no development of fungal spores compared to the controls bottles, after 3 days. No colonies of both yeast and mold were detected after 7 days in eight out of nine active bottles. This exception might be due to the inconstant method of bottle preparation, meaning that the exact amount of the active material in each bottle is unknown and may be that in the exception bottle the amount of the active material was less than in the others.

From Table 3 it can be seen that in the control bottles the mold development was inhibited when grown with yeast. The reason for the inhibited growth could be the competition on place and nutrients and the interaction between the yeast and the mold.

Once it was observed that the control bottles had no antibacterial activity after two sampling points, no more samples were taken from control bottles.

The color of the Nestea beverage and the pH in the active bottles remained the same as the control.

### Example 2

### Orange Juice

250 ml PET bottles were coated internally with active coating based on ion exchange resin mixtures in a matrix prepared in a form of thin sheet by heat forming. The active mixtures consisted of IERM.

TABLE 4
sheets details

| | | | weight | | | |
|---|---|---|---|---|---|---|
| | active | % of act. | active | | | |
| type | material | Material | material | EVA | diameter | thickness |
| mix | MBD30 | 75% | 5 | 15 | 180 mm | 0.8 mm |
| mix | amberlyst | 50% | 10 | 10 | 180 mm | 0.5 mm |
| | 15 | | | | | |

TABLE 5
bottle details

| | | | | | Total | | |
|---|---|---|---|---|---|---|---|
| batch | | | | Conc. | conc. | | |
| No. | type | materials | sheet | [g/%] | [g/%] | placement | mass |
| 12 | mix | IERM | 75% | 1.05 | 1.55 | bottom | 2.8 gr |
| | mix + | IERM | 50% | 0.5 | | 7 cm from | 2 gr |
| | Matrix | | | | | bottom | |
| | one side | | | | | | |

Coated bottles were filled with natural 100% pure squeezed orange juice (PRIGAT). The orange juice was inoculated with a yeast cocktail, a mold cocktail or a bacterial cocktail. For control, bottles coated with a matrix and uncoated bottles were used. The bottles were incubated at 30° C. Bottles (n=3) were sampled after 3 and 7 days and plated on Malt extract agar for yeast and mold and MRS agar and mannitol agar for bacteria using the pour plate method. pH was also measured at the same time points. The plates were incubated at 30° C. and counted after 24-48 hours. The results are summarized in tables 6-8 below.

TABLE 6
Yeast viable counts in test bottles with Orange juice.

| | | Time zero | | 3 days | | 7 days | |
|---|---|---|---|---|---|---|---|
| | Tube no. | CFU/ml | pH | CFU/ml | pH | CFU/ml | pH |
| ctrl | 1 | 8.0E+03 | 3.5 | 1.4E+08 | 3.5 | 1.3E+07 | 3.7 |
| | 2 | | 3.5 | 1.0E+08 | 3.5 | 8.0E+06 | 3.7 |
| | 3 | | 3.5 | 1.3E+10 | 3.7 | 1.7E+07 | 3.7 |
| Matrix | 1 | 8.0E+03 | 3.5 | 2.8E+08 | 3.5 | 2.8E+07 | 3.7 |
| | 2 | | 3.5 | 1.7E+08 | 3.7 | 1.8E+07 | 3.7 |
| | 3 | | 3.5 | 1.6E+08 | 3.5 | 3.2E+07 | 3.7 |
| IERM | 1 | 8.0E+03 | 3.5 | 2.4E+03 | 3.5 | <1 | 3.5 |
| | 2 | | 3.5 | 1.8E+03 | 3.5 | <1 | 3.5 |
| | 3 | | 3.5 | 2.9E+03 | 3.5 | <1 | 3.5 |

TABLE 7
Mold viable counts in test bottles with Orange juice.

| | | Time zero | | 3 days | | 7 days | |
|---|---|---|---|---|---|---|---|
| | Tube no. | CFU/ml | pH | CFU/ml | pH | CFU/ml | pH |
| ctrl | 1 | 8.0E+03 | 3.5 | 4.0E+05 | 3.7 | 1.3E+06 | 3.7 |
| | 2 | | 3.5 | 5.0E+05 | 3.7 | 1.4E+06 | 3.7 |
| | 3 | | 3.5 | 2.0E+05 | 3.7 | 1.5E+06 | 3.7 |
| Matrix | 1 | 8.0E+03 | 3.5 | 9.0E+04 | 3.5 | 3.0E+05 | 3.7 |
| | 2 | | 3.5 | 3.0E+04 | 3.5 | 5.0E+05 | 3.7 |
| | 3 | | 3.5 | 1.0E+05 | 3.5 | 1.5E+05 | 3.7 |
| IERM | 1 | 8.0E+03 | 3.5 | <1 | 3.5 | <1 | 3.5 |
| | 2 | | 3.5 | *Y.C | 3 | <1 | 3.5 |
| | 3 | | 3.5 | <1 | 3.5 | <1 | 3.5 |

*Y.C—yeast contamination

TABLE 8A
Lactobacillus plantarum viable counts in test bottles with orange juice.
MRS for Lactobacillus plantarum

| | | Time zero | | 3 days | | 7 days | |
|---|---|---|---|---|---|---|---|
| | Tube no. | CFU/ml | pH | CFU/ml | pH | CFU/ml | pH |
| ctrl | 1 | 3.2E+03 | 3.5 | 6.8E+08 | 3.5 | 6.9E+08 | 3.5 |
| | 2 | | 3.5 | 6.3E+08 | 3.5 | 4.4E+08 | 3.5 |
| | 3 | | 3.5 | 9.3E+08 | 3.5 | 9.4E+08 | 3.5 |
| Matrix | 1 | 3.2E+03 | 3.5 | 4.5E+08 | 3.5 | 5.9E+08 | 3.5 |
| | 2 | | 3.5 | 3.5E+08 | 3.5 | 6.0E+09 | 3.5 |
| | 3 | | 3.5 | 3.0E+08 | 3.5 | 7.4E+08 | 3.5 |
| IERM | 1 | 3.2E+03 | 3.5 | 2.9E+02 | 3.5 | 1.8E+02 | 3.7 |
| | 2 | | 3.5 | 3.0E+02 | 3.5 | 1.9E+01 | 3.7 |
| | 3 | | 3.5 | 7.6E+02 | 3.5 | 4.0E+01 | 3.7 |

TABLE 8B
Acetobacter aceti viable counts in test bottles with orange juice.
Manitol for Acetobacter aceti

| | | Time zero | | 3 days | | 7 days | |
|---|---|---|---|---|---|---|---|
| | Tube no. | CFU/ml | pH | CFU/ml | pH | CFU/ml | pH |
| ctrl | 1 | 3.2E+03 | 3.5 | 5.5E+08 | 3.5 | 5.1E+08 | 3.5 |
| | 2 | | 3.5 | 7.8E+08 | 3.5 | 1.4E+09 | 3.5 |
| | 3 | | 3.5 | 8.0E+08 | 3.5 | 7.2E+08 | 3.5 |
| Matrix | 1 | 3.2E+03 | 3.5 | 2.6E+08 | 3.5 | 4.5E+08 | 3.5 |
| | 2 | | 3.5 | 2.0E+08 | 3.5 | 4.4E+08 | 3.5 |
| | 3 | | 3.5 | 3.7E+08 | 3.5 | 7.0E+08 | 3.5 |
| IERM | 1 | 3.2E+03 | 3.5 | 2.3E+02 | 3.5 | 6.1E+02 | 3.7 |
| | 2 | | 3.5 | 2.2E+02 | 3.5 | <1 | 3.7 |
| | 3 | | 3.5 | 9.0E+01 | 3.5 | 2.1E+03 | 3.7 |

As seen from the results there was a six logs reduction in the bacteria concentration and a total killing of the mold and the yeast after 3 days and a week, respectively.

The pH of the juice remained stable (pH=˜3.5) in all bottles (the active bottles and the controls).

### Example 3

### Test of Composition of Treated Orange Juice

Orange juice from EXAMPLE 2 was analyzed for its content and composition following the exposure to the active coating.

The results shown in Table 9 prove that the exposure to the bioactive coating negligibly affects the content of the juice.

[symbol]

TABLE 9
Content of orange juice following treatement

| | | | Test 1 | | | | Test 2 | | | | |
|---|---|---|---|---|---|---|---|---|---|---|---|
| | | | Control | Matrix | IERM1 | IERM2 | Control | Matrix | IERM1 | IERM2 | Guideline |
| | Citric | g/100 | 0.83 | 0.82 | 0.75 | 0.78 | 0.91 | 0.92 | 0.9 | 0.91 | 0.63-1.7 |
| | Acid | ml | | | | | | | | | |
| | Ascorbic | mg/L | 2.3 | 9.6 | <2 | <2 | <2 | 6.64 | <2 | <2 | |
| | acid | | | | | | | | | | |
| | (Vitamin | | | | | | | | | | |
| | C) | | | | | | | | | | |
| calcium | Ca | mg/Kg | 130 | 111 | 65 | 95 | 110 | 110 | 90 | 100 | 50-160 |
| copper | Cu | mg/Kg | 0.291 | 0.28 | 0.25 | 0.257 | 0.265 | 0.25 | 0.27 | 0.261 | <5 |
| iron | Fe | mg/Kg | 0.968 | 0.9 | 0.515 | 0.693 | 0.9 | 0.9 | 0.709 | 0.708 | <5 |
| potassium | K | mg/Kg | 1293 | 1260 | 1260 | 1129 | 1296 | 1425 | 813 | 1093 | 1300-2500 |
| magnesium | Mg | mg/Kg | 90 | 87 | 56.5 | 72 | 888 | 88 | 70 | 73 | 16-70 |
| manganese | Mn | mg/Kg | 0.211 | 0.19 | 0.133 | 0.162 | 0.22 | 0.21 | 0.166 | 0.18 | |
| sodium | Na | mg/Kg | 50 | 46 | 88 | 45 | 25.7 | 27 | 18 | 78 | <30 |
| phosphorus | P | mg/Kg | 160 | 150 | 130 | 130 | 150 | 155 | 155 | 160 | 115-210 |
| sulfur | S | mg/Kg | 52 | 51 | 55 | 50 | 50 | 49 | 56 | 60 | |
| strontium | Sr | mg/Kg | 0.535 | 0.48 | 0.252 | 0.367 | 0.423 | 0.39 | 0.367 | 0.384 | |

### Example 4

Various well known carbonated beverages, soft drinks, tea, flavoured tea, milk products and milk powder beverages, and drinking waters are held in various plastic containers, cartons or cans which are coated with bioactive material such as sulfonated tetrafluoroethylene copolymer (NAFION), for differing periods of time ranging from 60 seconds to several weeks. In all cases the pH varies by less than 0.2 units from the beginning to the end of the trial.

### Example 5

Various well known carbonated beverages, soft drinks, tea, flavoured tea, milk products and milk powder beverages, and drinking waters are held in various plastic containers, cartons and cans which are coated with bioactive material such as sulfonated tetrafluoroethylene copolymer (NAFION), for differing periods of time ranging from 60 seconds to several weeks. In all cases the organoleptic parameters remain substantially the same from the beginning to the end of the trial.

### Example 6

Various well known carbonated beverages, soft drinks, tea, flavoured tea, milk products and milk powder beverages, and drinking waters are held in various plastic containers, cartons and cans which are coated with bioactive material such as sulfonated tetrafluoroethylene copolymer (NAFION) for differing periods of time ranging from 60 seconds to several weeks. In all cases concentrations of pathogens and beverage spoiling microbes (Beverage spoiling microorganisms) remain substantially the same from the beginning to the end of the trial.

### Example 7

Various well known carbonated beverages, soft drinks, tea, flavoured tea, milk products and milk powder beverages, and drinking waters are held for differing periods of time ranging from 60 seconds to several weeks, in various containers, cartons or cans, additionally comprising inserts of various types and geometries, The inserts have been coated with bioactive material such as sulfonated tetrafluoroethylene copolymer (NAFION)

In all cases the pH varies by less than 0.2 units from the beginning to the end of the trial.

### Example 8

Various well known carbonated beverages, soft drinks, tea, flavoured tea, milk products and milk powder beverages, and drinking waters are held for differing periods of time ranging from 60 seconds to several weeks, in various containers, cartons or cans, additionally comprising inserts of various types and geometries, The inserts have been coated with bioactive material such as sulfonated tetrafluoroethylene copolymer (NAFION)

In all cases the organoleptic parameters remain substantially the same from the beginning to the end of the trial.

### Example 9

Various well known carbonated beverages, soft drinks, tea, flavoured tea, milk products and milk powder beverages, and drinking waters are held for differing periods of time ranging from 60 seconds to several weeks, in various containers, cartons or cans, additionally comprising inserts of various types and geometries, The inserts have been coated with bioactive material such as sulfonated tetrafluoroethylene copolymer (NAFION)

In some trials the caps and closures alone have been coated, and in some trials both the containers and the caps and closures have been coated.

In all cases concentrations of pathogens and beverage spoiling microorganisms remained substantially the same from the beginning to the end of the trial.

### Example 10

Various well known carbonated beverages, soft drinks, tea, flavoured tea, milk products and milk powder beverages, and drinking waters are held for differing periods of time ranging from 60 seconds to several weeks, in various containers, cartons or cans, additionally comprising caps and closures of various types and geometries which have been coated with bioactive material such as sulfonated tetrafluoroethylene copolymer (NAFION). In some trials the caps and closures alone have been coated, and in some trials both the containers and the caps and closures have been coated.

In all cases the pH varies by less than 0.2 units from the beginning to the end of the trial.

### Example 11

Various well known carbonated beverages, soft drinks, tea, flavoured tea, milk products and milk powder beverages, and drinking waters are held for differing periods of time ranging from 60 seconds to several weeks, in various containers, cartons or cans, additionally comprising caps and closures of various types and geometries which have been coated with bioactive material such as sulfonated tetrafluoroethylene copolymer (NAFION). In some trials the caps and closures alone have been coated, and in some trials both the containers and the caps and closures have been coated.

In all cases the organoleptic parameters remain substantially the same from the beginning to the end of the trial.

### Example 12

Various well known carbonated beverages, soft drinks, tea, flavoured tea, milk products and milk powder beverages, and drinking waters are held for differing periods of time ranging from 60 seconds to several weeks, in various containers, cartons or cans, additionally comprising caps and closures of various types and geometries which have been coated with bioactive material such as sulfonated tetrafluoroethylene copolymer (NAFION). In some trials the caps and closures alone have been coated, and in some trials both the containers and the caps and closures have been coated.

In all cases concentrations of pathogens and beverage spoiling microbes (Beverage spoiling microorganisms) remain substantially the same from the beginning to the end of the trial.

Additionally, other trials demonstrate that any combination of container, insert and closure coated with the above-mentioned bioactive material is successful in protecting any of the above mentioned carbonated beverages, soft drinks, tea, flavoured tea, milk products and milk powder beverages, and drinking waters, in that pH is maintained, organoleptic properties are unaffected, and the concentrations of pathogens and beverage spoiling microbes (Beverage spoiling microorganisms) remain substantially the same from the beginning to the end of the trial.

Furthermore, in some trials similar to those reported above, Beverage spoiling microorganisms are substantially reduced from the beginning to the end of the trial, and the concentration of Beverage spoiling microorganisms remain within the normalized permitted amounts for each beverage.

### Example 13

### Bacterial Growth in Different Types of Cold (Iced) Tea

The following types of commercially available bottled cold (“iced”) teas were tested:
a. Arizona, Pomegranate Green Tea, M16509 06:07 CT790.
b. Arizona, Peach Iced Tea, M16209 08:13 CT790.
c. Arizona, Lemon Iced Tea, M19109 01:07 CT790.
d. Nestea, Lemon Iced Tea, 12/10/10 10116581.
e. San Benedetto, Peach Iced Tea, 27/05/2011 1519 LA0055P.
f. Jump, Lemon Iced Tea, 27/10/10 L0117 10:37.
g. Jump, Peach Iced Tea, 27/10/10 L0117 04:57.
h. Jump, Apple Iced Tea, 27/10/10 L0117 14:08.

The experiments were performed in 40 ml containers. The samples were inoculated with test microorganisms Lactobacillus plantarum (MRS medium) and Bacillus atrophaeus (NA medium). A pour plate sampling method was used. Samples were incubated at 30° C., and sampled at 0, 3, and 7 days following the start of incubation. The results are summarized in Tables 10 and 11.

TABLE 10
L. plantarum viable counts

| | Tube | Time zero | | 3 days | | 7 days | |
|---|---|---|---|---|---|---|---|
| | no. | CFU/ml | pH | CFU/ml | pH | CFU/ml | pH |
| Arizona | 1 | 5.0E+04 | 3 | 7.0E+00 | 2.98 | <1 | 2.93 |
| Pomegranate | 2 | | 3 | 1.1E+01 | 2.97 | <1 | 2.96 |
| Green Tea | 3 | | 3 | 3.0E+00 | 2.99 | <1 | 2.95 |
| Average | | 5.0E+04 | 3 | 7.0E+00 | 2.98 | <1 | 2.95 |
| Nestea | 1 | 3.0E+04 | 3.5 | 1.0E+02 | 3.49 | <1 | 3.48 |
| Lemon | 2 | | 3.5 | 1.1E+02 | 3.45 | <1 | 3.44 |
| | 3 | | 3.5 | 5.0E+01 | 3.51 | <1 | 3.49 |
| Average | | 3.0E+04 | 3.5 | 8.7E+01 | 3.48 | <1 | 3.47 |
| Arizona | 1 | 3.0E+04 | 2.9 | Mold | 2.88 | Mold | 2.86 |
| Lemon | 2 | | 2.9 | Mold | 2.88 | Mold | 2.84 |
| Iced Tea | 3 | | 2.9 | Mold | 2.91 | Mold | 2.99 |
| Average | | 3.0E+04 | 2.9 | Mold | 2.89 | Mold | 2.9 |
| Arizona | 1 | 5.2E+04 | 3.1 | <1 | 3.14 | <1 | 3.07 |
| Peach | 2 | | 3.1 | <1 | 3.12 | <1 | 3.07 |
| Iced Tea | 3 | | 3.1 | <1 | 3.14 | <1 | 3.07 |
| Average | | 5.2E+04 | 3.1 | <1 | 3.13 | <1 | 3.07 |
| Jump | 1 | 4.3E+04 | 3.1 | 3.4E+01 | 3.12 | Yeast | 3.07 |
| Lemon | 2 | | 3.1 | 9.0E+00 | 3.12 | Yeast | 3.08 |
| Iced Tea | 3 | | 3.1 | 3.1E+01 | 3.15 | Yeast | 3.1 |
| Average | | 4.3E+04 | 3.1 | 2.5E+01 | 3.13 | Yeast | 3.08 |
| Jump | 1 | 5.0E+04 | 3.2 | <1 | 3.17 | <1 | 3.11 |
| Peach | 2 | | 3.2 | <1 | 3.16 | <1 | 3.13 |
| Iced Tea | 3 | | 3.2 | <1 | 3.15 | <1 | 3.08 |
| Average | | 5.0E+04 | 3.2 | <1 | 3.16 | <1 | 3.11 |
| Jump | 1 | 4.0E+04 | 3.2 | 5.0E+00 | 3.16 | Mold | 3.14 |
| Apple | 2 | | 3.2 | <1 | 3.17 | Mold | 3.12 |
| Iced Tea | 3 | | 3.2 | <1 | 3.17 | Mold | 3.12 |
| Average | | 5.0E+04 | 3.2 | 1.7E+00 | 3.17 | Mold | 3.13 |
| San | 1 | 3.2E+04 | 3.2 | <1 | 3.18 | <1 | 3.1 |
| Benedetto | 2 | | 3.2 | <1 | 3.16 | <1 | 3.1 |
| Peach | 3 | | 3.2 | <1 | 3.17 | <1 | 3.1 |
| Iced Tea | | | | | | | |
| Average | | 5.0E+04 | 3.2 | <1 | 3.17 | <1 | 3.1 |

[symbol]

TABLE 11
B. atrophaeus viable counts.

| | Tube | Time zero | | 3 days | | 3 days | |
|---|---|---|---|---|---|---|---|
| | no. | CFU/ml | pH | CFU/ml | pH | CFU/ml | pH |
| Arizona | 1 | 2.2E+02 | 3 | <1 | 3.0 | <1 | 3.0 |
| Pomegranate | 2 | | 3 | 2.0E+00 | 3.0 | <1 | 2.9 |
| Green Tea | 3 | | 3 | 2.0E+00 | 3.0 | <1 | 2.9 |
| Average | | 2.2E+02 | 3 | 1.3E+00 | 3.0 | <1 | 2.9 |
| Nestea | 1 | 2.6E+02 | 3.5 | 6.0E+00 | 3.5 | <1 | 3.5 |
| Lemon | 2 | | 3.51 | 2.0E+00 | 3.6 | <1 | 3.5 |
| | 3 | | 3.51 | 4.0E+00 | 3.5 | <1 | 3.5 |
| Average | | 2.6E+02 | 3.51 | 4.0E+00 | 3.5 | <1 | 3.5 |
| Arizona | 1 | 1.9E+02 | 2.88 | Mold | 2.9 | Mold | 2.9 |
| Lemon | 2 | | 2.88 | Mold | 2.9 | Mold | 2.9 |
| Iced Tea | 3 | | 2.88 | Mold | 2.9 | Mold | 2.9 |
| Average | | 1.9E+02 | 2.88 | Mold | 2.9 | Mold | 2.9 |
| Arizona | 1 | 1.1E+02 | 3.13 | <1 | 3.1 | <1 | 3.1 |
| Peach | 2 | | 3.13 | <1 | 3.1 | <1 | 3.1 |
| Iced Tea | 3 | | 3.13 | <1 | 3.1 | <1 | 3.1 |
| Average | | 1.1E+02 | 3.13 | <1 | 3.1 | <1 | 3.1 |
| Jump | 1 | 1.8E+02 | 3.11 | 5.8E+02 | 3.1 | Yeast | 3.1 |
| Lemon | 2 | | 3.11 | 3.6E+03 | 3.1 | Yeast | 3.1 |
| Iced Tea | 3 | | 3.11 | 3.6E+01 | 3.1 | Yeast | 3.1 |
| Average | | 1.8E+02 | 3.11 | 1.4E+03 | 3.1 | Yeast | 3.1 |
| Jump | 1 | 1.7E+02 | 3.15 | <1 | 3.2 | <1 | 3.1 |
| Peach | 2 | | 3.15 | 3.0E+00 | 3.2 | <1 | 3.1 |
| Iced Tea | 3 | | 3.15 | 3.0E+00 | 3.2 | <1 | 3.1 |
| Average | | 1.7E+02 | 3.15 | 2.0E+00 | 3.2 | <1 | 3.1 |
| Jump | 1 | 1.5E+02 | 3.17 | 3.9E+02 | 3.2 | Mold | 3.1 |
| Apple | 2 | | 3.17 | <1 | 3.2 | Mold | 3.1 |
| Iced Tea | 3 | | 3.17 | 4.0E+00 | 3.2 | Mold | 3.1 |
| Average | | 1.5E+02 | 3.17 | 1.3E+02 | 3.2 | Mold | 3.1 |
| San | 1 | 2.0E+02 | 3.16 | 1.6E+01 | 3.2 | <1 | 3.1 |
| Benedetto | 2 | | 3.16 | 9.0E+00 | 3.2 | <1 | 3.1 |
| Peach | 3 | | 3.16 | 5.0E+00 | 3.2 | <1 | 3.1 |
| Iced Tea | | | | | | | |
| Average | | 2.0E+02 | 3.16 | 1.0E+01 | 3.2 | <1 | 3.1 |

[symbol]

As can be seen from the results given in Tables 10 and 11, neither L. plantarum nor B. atrophaeus prospered in the tested beverages. Even after seven days, there were no viable bacteria in any of the tested beverages. Even though the beverages were inoculated with bacteria, mold developed In the Arizona Lemon Iced Tea & Jump Apple Iced Tea and yeast developed in the Jump Lemon Iced Tea.

### Example 14

### Inhibition of Yeast Growth in Nestea

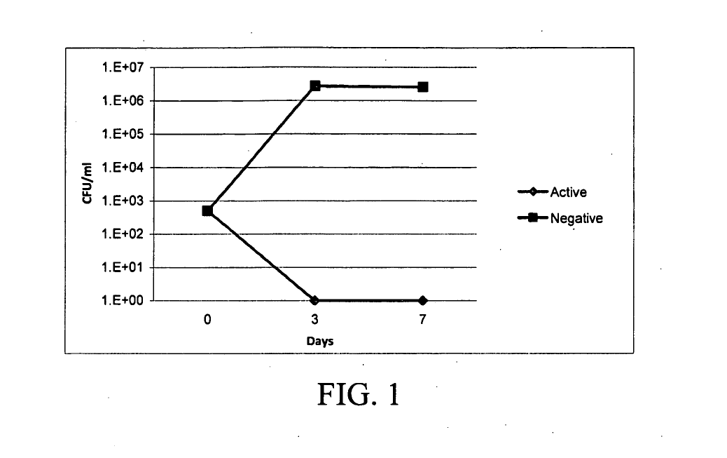

Samples of NESTEA Lemon-flavored tea were obtained and placed in 500 ml containers. The yeasts tested included Saccharomyces cerevisiae and Zygosaccharomyces rouxii in malt extract agar media. Initial concentrations were 5.0×10² CFU ml⁻¹. Samples were incubated at 30° C., and sampled at 0, 3, and 7 days following the start of incubation. The results are summarized in Table 12. A comparison of the number of viable counts in the experimental and control systems as a function of time following inoculation is shown graphically in FIG. 1.

[symbol]

TABLE 12
Yeast viable counts in OPLON test bottles with Nestea.

| | Bot- | | | | | | |
|---|---|---|---|---|---|---|---|
| | tle | Time zero | | 3 Days | | 7 Days | |
| | no. | CFU/ml | pH | CFU/ml | pH | CFU/ml | pH |
| Nega- | 1 | 5.0E+02 | 3.56 | 2.4E+06 | 3.58 | 3.0E+06 | 3.61 |
| tive | 2 | 5.0E+02 | 3.56 | 3.0E+06 | 3.57 | 2.0E+06 | 3.56 |
| Control | 3 | 5.0E+02 | 3.56 | 2.8E+06 | 3.57 | 2.8E+06 | 3.55 |
| | Aver- | 5.0E+02 | 3.56 | 2.7E+06 | 3.57 | 2.6E+06 | 3.57 |
| | age | | | | | | |
| Active | 1 | 5.0E+02 | 3.56 | 0 | 3.92 | 0 | 3.92 |
| | 2 | 5.0E+02 | 3.56 | 0 | 3.98 | 0 | 3.98 |
| | 3 | 5.0E+02 | 3.56 | 0 | 3.87 | 0 | 3.86 |
| | Aver- | 5.0E+02 | 3.56 | 0 | 3.92 | 0 | 3.92 |
| | age | | | | | | |

As can be seen from the results summarized in the table and presented in the graph, the method herein disclosed succeeded in eradicating yeast from NESTEA within three days, and the NESTEA remained free of yeast for at least a week after inoculation, while the pH in the experimental rose less than 0.4 pH units during the course of the experiment.

1. A method of producing a liquid or liquid concentrate having an extended shelf life or substantially free of beverage spoiling microorganisms, said method comprising:
a. obtaining a liquid or a liquid concentrate;
b. obtaining a bioactive material that does not affect a predetermined set of organoleptic parameters of said liquid or said liquid concentrate; and,
c. treating said liquid or said liquid concentrate with said bioactive material to obtain a liquid or liquid concentrate having an extended shelf life or substantially free of beverage spoiling microorganisms.

2. The method of producing a liquid substantially free of beverage spoiling microorganisms according to claim 1, wherein treating said liquid with said bioactive material comprises:
treating said liquid with said bioactive material until the concentration of beverage-spoiling microorganisms falls below a predetermined threshold.

3. The method of producing a liquid substantially free of beverage spoiling microorganisms according to claim 1, said method comprising:
a. obtaining a liquid concentrate and obtaining a diluent;
b. obtaining a bioactive material that does not affect a predetermined set of organoleptic parameters of said liquid;
c. treating said liquid concentrate with said bioactive material until the concentration of beverage-spoiling microorganisms falls below a predetermined threshold; and,
d. combining said diluent with the treated concentrate.

4. The method of producing an extended shelf life liquid according to claim 1, said method comprising:
a. obtaining a liquid concentrate;
b. obtaining a diluent;
c. obtaining a bioactive material that does not affect a predetermined set of organoleptic parameters of said concentrate;
d. treating said liquid concentrate with said bioactive material; and,
e. combining said diluent with the treated concentrate to obtain a liquid having an extended shelf life.

5. The method of producing a liquid concentrate substantially free of beverage-spoiling microorganisms according to claim 1, wherein said method comprising:
a. obtaining a liquid concentrate;
b. obtaining a bioactive material that does not affect a predetermined set of organoleptic parameters of said concentrate; and,
c. treating said liquid concentrate with said bioactive material until the concentration of beverage-spoiling microorganisms falls below a predetermined threshold.

6. The method of producing an extended shelf life liquid concentrate according to claim 1, wherein said method comprising:
a. obtaining a liquid concentrate;
b. obtaining a bioactive material that does not affect a predetermined set of organoleptic parameters of said concentrate; and,
c. treating said liquid concentrate with said bioactive material concentrate to obtain a liquid concentrate having an extended shelf life.

7. The method according to claim 4, wherein said diluent is selected from the group consisting of (a) water and (b) carbonated water.

8. (canceled)

9. The method according to claim 1, wherein said bioactive material comprises a solid substantially insoluble in water which, when in contact with a water-containing environment, carries strongly acid and/or strongly basic functional groups; has a pH of less than about 4.5 or greater than about 8.0; and is in a form chosen from the group consisting of (i) H⁺ and (ii) OH⁻.

10. (canceled)

11. (canceled)

12. The method according to claim 9, wherein said bioactive material when accessible to water, has a buffering capacity of about 20 to about 100 mM H⁺/L/pH unit.

13. (canceled)

14. The method according to claim 9, wherein said bioactive material comprises at least one polymer chosen from the group consisting of (a) polyvinyl alcohol; (b) polystyrene sulfonate; and (c) polypropylene polystyrene-divinylbenzene.

15. The method according to claim 14, wherein said at least one polymer contains at least one functional group chosen from the group consisting of SO₃H and H₂N(CH₃).

16. (canceled)

17. The method according to claim 9, wherein said bioactive material comprises two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

18. The method according to claim 9, wherein said bioactive material comprises a surface with a given functionality and at least one external proton-permeable layer, each of which of said at least one external proton-permeable layers is disposed on at least a portion of said surface.

19. The method according to claim 9, wherein said bioactive material comprises at least one charged polymer and at least one bather adapted to prevent heavy ion diffusion.

20. (canceled)

21. The method according to claim 9, wherein said bioactive material has at least one characteristic selected from the group consisting of:
a. capacity for absorbing or releasing protons capable of regeneration;
b. buffering capacity capable of regeneration; and,
c. proton conductivity capable of regeneration.

22. The method according claim 1, wherein said predetermined set of organoleptic parameters comprises at least one organoleptic parameter chosen from the group consisting of: concentration of at least one predetermined water-soluble substance; size distribution of insoluble substances; initial taste; flavor; aftertaste; odor; color; appearance; texture; feel in the mouth; astringency; sweetness; bitterness; saltiness; off flavors; viscosity.

23. The method according claim 1, wherein said bioactive material does not affect a predetermined set of organoleptic parameters as measured by the methods defined by ASTM standard E2454-05.

24. (canceled)

25. The method according claim 2, wherein said predetermined threshold comprises the maximum concentration set by law.

26. The method according claim 1, wherein said predetermined threshold comprises 10⁻² CFU ml⁻¹.

27. (canceled)

28. (canceled)

29. The method according claim 1, wherein said liquid is chosen from the group consisting of (a) a beverage; (b) a foodstuff that is at least partially fluid; (c) a medication; (d) a lotion; (e) a cream; (f) an ointment; and (g) a cosmetic.

30. (canceled)

31. (canceled)

32. The method according claim 1, further comprising a step of bottling the treated liquid in a manner chosen from the group consisting of (a) anaerobically, (b) aerobically, (c) by a means other than hot filling, and (d) by a means other than aseptic filling.

33. (canceled)

34. (canceled)

35. (canceled)

36. (canceled)

37. The method according claim 1, further comprising a step of bottling the treated liquid in a bottle with a headspace.

38. The method according claim 1, further comprising a step of bottling the treated liquid in a bottle without a headspace.

39. A liquid or liquid concentrate produced according to the method of claim 1.

40. The liquid according to claim 39, wherein said liquid is selected from the group consisting of a beverage, a foodstuff, a medication, and a cosmetic.

41. (canceled)

42. (canceled)

43. (canceled)

44. The liquid according to claim 39, wherein said liquid is at least partially contained within a substance chosen from the group consisting of (a) foodstuffs, (b) medications, and (c) cosmetics.

45. The liquid or liquid concentrate according to claim 39, wherein said liquid or liquid concentrate is stored in a container comprising said bioactive material.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. The liquid or liquid concentrate according to claim 45, wherein said container is adapted to be stored in a position chosen from the group consisting of vernally, horizontally, or inverted.

59. The liquid or liquid concentrate according to claim 45, wherein said container is adapted to be stored in a plurality of positions and further adapted to have its storage position changed between at least two of said plurality of storage positions at least once during a time that said container is being stored.

60. The liquid according to claim 59, wherein said change in said storage position is performed after a preset interval following the commencement of said storage, wherein said preset interval is less than or equal to about 120 days.

61. (canceled)

62. (canceled)

63. (canceled)

64. (canceled)

65. (canceled)

66. (canceled)

67. The liquid or liquid concentrate according to claim 45, wherein said container further comprises an insert, said insert comprising said bioactive material.

68. The liquid or liquid concentrate according to claim 45, wherein said container further comprises a closure comprising said bioactive material, wherein the closure is selected from the group consisting of a plug, stopper, cap, screw-on cap, or seal.

69. (canceled)

70. The liquid or liquid concentrate according to claim 68, wherein said bioactive material is incorporated into the material from which said closure is constructed.

71. The liquid or liquid concentrate according to claim 68, wherein said bioactive material is disposed as a layer on at least part of the inner surface of said closure.

72. The liquid or liquid concentrate according to claim 68, wherein said closure comprises a lining, said lining disposed about at least part of the inner surface of said closure and said lining comprising said bioactive material.

73. The liquid or liquid concentrate according to claim 68, wherein said closure comprises an insert, said insert disposed about at least a part of the inner surface of said closure, said insert comprising said bioactive material.

74. (canceled)

75. The liquid or liquid concentrate according to claim 45, wherein said lumen of said container is has a flowability of more than an effective measure according to ASTM standard C1339 or ASTM standard D6103.

76. (canceled)

77. The liquid or liquid concentrate according to claim 45, wherein said container additionally comprises an effective measure of at least one additive.

78. (canceled)

79. The liquid according to claim 39, wherein said liquid is adapted to be served from a dispenser, wherein said dispenser is chosen from the group consisting of soda fountain, vending machine, and carbonated beverage dispenser.

80. (canceled)

81. The liquid according to claim 79, wherein said liquid is reconstituted within said dispenser from a concentrate and at least one diluent.

82. The liquid or liquid concentrate according to claim 39, wherein said liquid is at least partially produced by a continuous flow process.

83. The liquid or liquid concentrate according to claim 39, wherein said liquid is at least partially produced by a batch process.

84. (canceled)

85. The liquid concentrate according to claim 39, wherein said liquid concentrate is a beverage concentrate.

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. The liquid concentrate according to claim 39, wherein said liquid concentrate is adapted to be reconstituted into a beverage adapted to be served from a dispenser, wherein said dispenser is chosen from the group consisting of soda fountain, vending machine, and carbonated beverage dispenser.

121. (canceled)

122. The liquid concentrate according to claim 120, wherein said liquid is reconstituted within said dispenser from said liquid concentrate and at least one diluent.

123. (canceled)

124. (canceled)

125. (canceled)

126. (canceled)

127. (canceled)

128. (canceled)

129. (canceled)

130. (canceled)

131. (canceled)
